(19) United States
(12) Patent Application Publication
(10) Pub. No.: US 2017/0118328 A1
(43) Pub. Date: Apr. 27, 2017

(54) INFORMATION PROCESSING DEVICE, STATE CONTROL DEVICE, INFORMATION PROCESSING METHOD, STATE CONTROL METHOD, AND PROGRAM

(71) Applicant: SONY CORPORATION, Tokyo (JP)

(72) Inventors: Masashi ISHIKAWA, Kanagawa (JP); Masahiro SUEYOSHI, Kanagawa (JP); Tomohiko NAGAYAMA, Tokyo (JP)

(73) Assignee: SONY CORPORATION, Tokyo (JP)

(21) Appl. No.: 15/318,900

(22) PCT Filed: May 26, 2015
(86) PCT No.: PCT/JP2015/065042

§ 371 Date: Dec. 14, 2016

(30) Foreign Application Priority Data
Jul. 15, 2014 (JP) 2014-145225

(51) Int. Cl. H04M 3/42; G06Q 20/06; G06Q 20/32

(52) U.S. Cl. CPC H04M 3/42; G06Q 20/3278; G06Q 20/065

(57) ABSTRACT

Provided is an information processing device including: a state control unit configured to set, for each application, access states of an application which indicate possibility of execution of an application based on first communication and possibility of execution of the application based on second communication whose communication scheme is different from a communication scheme of the first communication. The access states capable of being set by the state control unit include an authentication available state in which execution of an application based on the first communication and execution of the application based on the second communication are selectively permitted according to a communication state of the first communication.

### TECHNICAL FIELD

The present disclosure relates to an information processing device, a state control device, an information processing method, a state control method, and a program.

### BACKGROUND ART

Technologies which enable a process to be selectively executed according to a state of communication have been developed. As a technology in which a payment process is executed when communication with a base station is possible, for example, the technology disclosed in Patent Literature 1 below is exemplified.

### CITATION LIST

### Patent Literature

Patent Literature 1: JP 2007-122457A

### SUMMARY OF INVENTION

### Technical Problem

When such a technology that enables a process to be selectively executed according to a state of communication is used, even if a device to which the technology is applied is lost or stolen and thus is handed over to a third person other than the user of the device, there is a possibility of the device being protected against processes being executed by the third person. Meanwhile, there is a need to set possibility of execution of an application which can be executed through communication with an external device to be more flexible.

The present disclosure proposes a novel and improved information processing device, state control device, information processing method, state control method, and program which enhance user convenience in executing an application.

### Solution to Problem

According to the present disclosure, there is provided an information processing device including: a state control unit configured to set, for each application, access states of an application which indicate possibility of execution of an application based on first communication and possibility of execution of the application based on second communication whose communication scheme is different from a communication scheme of the first communication. The access states capable of being set by the state control unit include an authentication available state in which execution of an application based on the first communication and execution of the application based on the second communication are selectively permitted according to a communication state of the first communication.

According to the present disclosure, there is provided a state control device including: a state control unit configured to cause an external device to set access states of an application which indicate possibility of execution of the application based on first communication and possibility of execution of the application based on second communication whose communication scheme is different from a communication scheme of the first communication. The access states capable of being set by the state control unit include an authentication available state in which execution of an application based on the first communication and execution of the application based on the second communication are selectively permitted according to a communication state of the first communication.

According to the present disclosure, there is provided an information processing method that is executed by an information processing device, the method including: a step of setting, for each application, access states of an application which indicate possibility of execution of an application based on first communication and possibility of execution of the application based on second communication whose communication scheme is different from a communication scheme of the first communication. The access states capable of being set in the setting step include an authentication available state in which execution of an application based on the first communication and execution of the application based on the second communication are selectively permitted according to a communication state of the first communication.

According to the present disclosure, there is provided a state control method that is executed by a state control device, the method including: a step of causing an external device to set access states of an application which indicate possibility of execution of the application based on first communication and possibility of execution of the application based on second communication whose communication scheme is different from a communication scheme of the first communication. The access states capable of being set in the setting step include an authentication available state in which execution of an application based on the first communication and execution of the application based on the second communication are selectively permitted according to a communication state of the first communication.

According to the present disclosure, there is provided a program that causes a computer to execute a step of setting, for each application, access states of an application which indicate possibility of execution of an application based on first communication and possibility of execution of the application based on second communication whose communication scheme is different from a communication scheme of the first communication. The access states capable of being set in the setting step include an authentication available state in which execution of an application based on the first communication and execution of the application based on the second communication are selectively permitted according to a communication state of the first communication.

According to the present disclosure, there is provided a program that causes a computer to execute a step of causing an external device to set access states of an application which indicate possibility of execution of the application based on first communication and possibility of execution of the application based on second communication whose communication scheme is different from a communication scheme of the first communication. The access states capable of being set in the setting step include an authentication available state in which execution of an application based on the first communication and execution of the application based on the second communication are selectively permitted according to a communication state of the first communication.

### Advantageous Effects of Invention

According to the present disclosure, enhancement of user convenience in executing an application can be achieved.

Note that the effects described above are not necessarily limited, and along with or instead of the effects, any effect that is desired to be introduced in the present specification or other effects that can be expected from the present specification may be exhibited.

### BRIEF DESCRIPTION OF DRAWINGS

FIG. 1 is an illustrative diagram showing an example of access states which can be set for applications according to the present embodiment.

FIG. 2 is a flowchart showing an example of a process of an information processing method according to the present embodiment.

FIG. 3 is an illustrative diagram for describing an example of a process of the information processing method according to the present embodiment.

FIG. 4 is a flowchart showing an example of the process of a state control method according to the present embodiment.

FIG. 5 is an illustrative diagram showing an example of a setting control screen according to the present embodiment.

FIG. 6 is a flowchart showing another example of the process of the information processing method according to the present embodiment.

FIG. 7 is a block diagram showing an example of a configuration of an information processing device according to the present embodiment.

FIG. 8 is an illustrative diagram showing an example of a hardware configuration of the information processing device according to the present embodiment.

FIG. 9 is an illustrative diagram showing an example of a configuration of an IC chip and an antenna shown in FIG. 8.

FIG. 10 is a block diagram showing an example of a configuration of a state control device according to the present embodiment.

FIG. 11 is an illustrative diagram showing an example of a hardware configuration of the state control device according to the present embodiment.

FIG. 12 is an illustrative diagram for describing a first use case according to the present embodiment.

FIG. 13 is an illustrative diagram for describing a first use case according to the present embodiment.

FIG. 14 is an illustrative diagram for describing a second use case according to the present embodiment.

FIG. 15 is an illustrative diagram for describing a second use case according to the present embodiment.

FIG. 16 is an illustrative diagram for describing a second use case according to the present embodiment.

### DESCRIPTION OF EMBODIMENT(S)

Hereinafter, (a) preferred embodiment(s) of the present disclosure will be described in detail with reference to the appended drawings. In this specification and the drawings, elements that have substantially the same function and structure are denoted with the same reference signs, and repeated explanation is omitted.

In addition, description will be provided in the following order.

1. Information processing method according to present embodiment

2. State control method according to present embodiment

3, Information processing device and state control device according to present embodiment

4. Program according to present embodiment

5. Use case according to present embodiment

### (Information Processing Method According to Present Embodiment)

First, an information processing method according to the present embodiment will be described. The information processing method according to the present embodiment will be described below exemplifying a case in which an information processing device according to the present embodiment performs a process of the information processing method according to the present embodiment.

### [1] Overview of Information Processing Method According to Present Embodiment

There is a need to set possibility of execution of an application which can be executed through communication with an external device to be more flexible, as described above.

To give a specific example with regard to an information processing device that can perform processes using near field communication (NFC), e.g., a contactless integrated circuit (IC) card, when a user performs a touch operation with respect to a reader/writer (or a device having a reader/writer function) using the information processing device, various processes such as payment are performed. However, when the information processing device is lost or stolen and thus is handed over to a third person, there is a risk of the information processing device being fraudulently used by the third person, and thus there is a need to restrict execution of applications based on communication such as NFC.

Here, the touch operation according to the present embodiment refers to, for example, an operation of moving an information processing device into a communication range in which communication based on NFC with a device which can communicate based on NFC (for example, a reader/writer for NFC, or a device having a reader/writer function) is possible.

In addition, information processing devices which can communicate based on a plurality of communication schemes, e.g., information processing devices which can perform communication based on NFC and communication based on another communication scheme such as Bluetooth Low Energy (BLE), have been introduced. Further, there are users who think that the touch operation is cumbersome to perform among users who are using such information processing devices which can perform communication based on NFC and communication based on another communication scheme such as BLE, and thus there is a need to make applications to be executed using the communication based on the communication scheme other than NFC.

Thus, the information processing device according to the present embodiment sets access states of an application which indicate possibility of execution of an application based on communication for each application (a state control process).

Here, an access state of an application according to the present embodiment is expressed by a combination of possibility of execution of the application based on first communication and possibility of execution of the application based on second communication whose communication scheme is different from that of the first communication.

As the first communication according to the present embodiment, communication based on an arbitrary communication scheme, for example, wireless communication using NFC, IEEE 802.15.1 such as BLE, IEEE 802.11, or infrared rays, wired communication using a local area network (LAN) or a Universal Serial Bus (USB), or the like is exemplified. The first communication according to the present embodiment is performed by, for example, a first communication unit (to be described below) which is provided in the information processing device according to the present embodiment and can perform the first communication, or an external communication device which is connected with the information processing device according to the present embodiment and can perform the first communication.

In addition, as the second communication according to the present embodiment, communication based on an arbitrary communication scheme, for example, wireless communication using NFC, IEEE 802.15.1 such as BLE, IEEE 802.11, or infrared rays, wired communication using a LAN or a USB, or the like is exemplified. The second communication according to the present embodiment is performed by, for example, a second communication unit (to be described below) which is provided in the information processing device according to the present embodiment and can perform the second communication, or an external communication device which is connected with the information processing device according to the present embodiment and can perform the second communication.

Combinations of the first communication according to the present embodiment and the second communication according to the present embodiment may be, for example, common for all applications that can be executed in the information processing device according to the present embodiment, or associated with respective applications. When the combinations of the first communication according to the present embodiment and the second communication according to the present embodiment are associated with respective applications, for example, even if the same access state is set for one application and another application, possibility of execution of the respective applications can be different.

A case in which the first communication according to the present embodiment is BLE and the second communication according to the present embodiment is NFC will be mainly exemplified. It is a matter of course that an example of combinations of the first communication according to the present embodiment and the second communication according to the present embodiment are not limited to the above example.

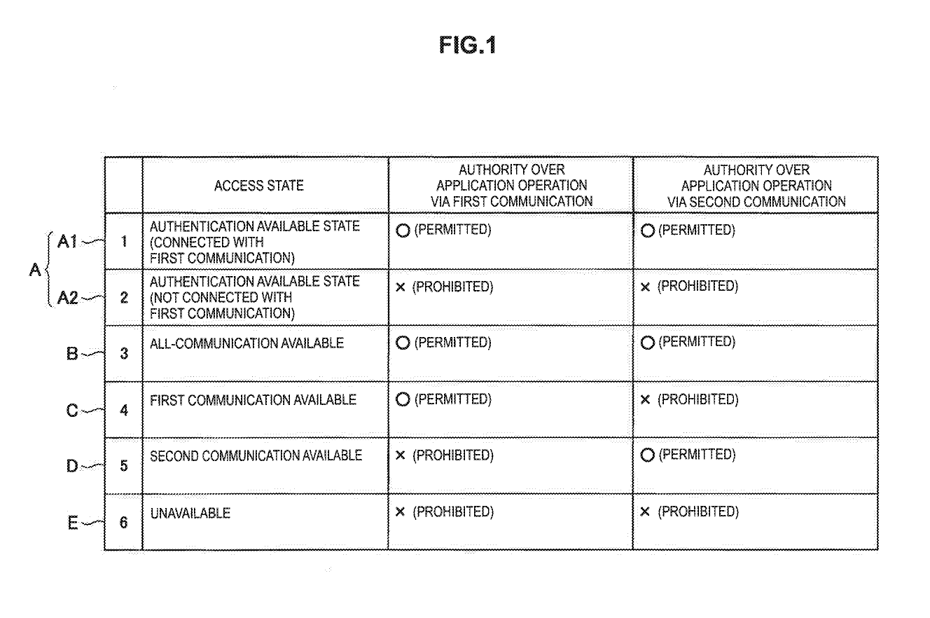

FIG. 1 is an illustrative diagram showing an example of access states which can be set for an application according to the present embodiment. Here, “prohibited” indicated for the access states of FIG. 1 refers to, for example, a state in which a communication function is available but the application gives no response (a state in which the application is not executed). In addition, “permitted” indicated for the access states of FIG. 1 refers to, for example, a state in which a communication function is available and the application gives a response (a state in which the application is executed).

The access states of the application according to the present embodiment include, for example, an authentication available state (A of FIG. 1), an all-communication available state (B of FIG. 1), a first communication available state (C of FIG. 1), a second communication available state (D of FIG. 1), and an unavailable state (E of FIG. 1).

The authentication available state (A of FIG. 1) is an access state in which execution of the application based on the first communication and execution of the application based on the second communication are selectively permitted according to a communication state of the first communication. The authentication available state according to the present embodiment is divided into two categories below.
“First authentication available state” in which execution of the application based on the first communication and execution thereof based on the second communication are permitted when a communication state of the first communication is a state in which communication is possible (which will be referred to as a “connected state” hereinbelow) (A1 of FIG. 1).
“Second authentication available state” in which neither execution of the application based on the first communication nor execution thereof based on the second communication is permitted when a communication state of the first communication is a state in which communication is not possible (which will be referred to as an “unconnected state” hereinbelow) (A2 of FIG. 1).

Here, as the connected state according to the present embodiment, a “state in which communication has been started,” or a “state in which communication has been started and authentication has been completed” is exemplified. In addition, as the unconnected state according to the present embodiment, a “state in which communication has not been started,” or a “state in which communication has been started but authentication has not been completed” is exemplified. The information processing device according to the present embodiment determines a communication state of the first communication using, for example, a setting associated with a communication scheme of the first communication (for example, a setting indicating necessity of authentication in determination of a communication state of the first communication) as a determination criterion.

In the case of a connected state of the first communication, execution based on the first communication and execution based on the second communication are permitted with respect to an application for which the authentication available state (A of FIG. 1) is set. In addition, in the case of an unconnected state of the first communication, neither execution based on the first communication nor execution based on the second communication is permitted with respect to the application for which the authentication available state (A of FIG. 1) is set.

Since the authentication available state (A of FIG. 1) is set for the application, the information processing device according to the present embodiment is in a state in which the application can be selectively executed according to a communication state of the first communication. Thus, since the authentication available state (A of FIG. 1) is set for the application, even if the information processing device according to the present embodiment is lost or stolen and thus is handed over to a third person, uses of the application by the third person can be prevented.

In addition, when authentication based on the first communication is related to determination of a communication state of the first communication with respect to the authentication available state (A of FIG. 1), data for authentication (for example, identification information of a device to be authenticated, or the like) is set as well when the authentication available state (A of FIG. 1) of the application is set.

The all-communication available state (B of FIG. 1) is an access state in which both execution of the application based on the first communication and execution of the application based on the second communication are permitted.

The application for which the all-communication available state (B of FIG. 1) is set can be executed using any of the first communication and the second communication. By setting the all-communication available state (B of FIG. 1) for the application, execution of the application without restriction is realized.

The first communication available state (C of FIG. 1) is an access state in which execution of the application based on the first communication is permitted but execution of the application based on the second communication is not permitted.

The application for which the first communication available state (C of FIG. 1) is set is not executed using the second communication, but can be executed using the first communication. Thus, by setting the first communication available state (C of FIG. 1) for the application, restriction on execution of the application based on the second communication is realized.

The second communication available state (D of FIG. 1) is an access state in which execution of the application based on the second communication is permitted but execution of the application based on the first communication is not permitted.

The application for which the second communication available state (D of FIG. 1) is set is not executed using the first communication, but can be executed using the second communication. Thus, by setting the second communication available state (D of FIG. 1) for the application, restriction on execution of the application based on the first communication is realized.

The unavailable state (E of FIG. 1) is an access state in which neither execution of the application based on the first communication nor execution of the application based on the second communication is permitted.

The application for which the unavailable state (E of FIG. 1) is set is not executed using any communication of the first communication and the second communication. Thus, by setting the unavailable state (E of FIG. 1) for the application, restriction on execution of the application based on communication is realized. In addition, by setting the unavailable state (E of FIG. 1) for the application, for example, it is possible to prevent the application from being executed through communication that a user does not intend and thus data from being acquired by a third person, e.g., skimming.

The information processing device according to the present embodiment performs a state control process as a process of the information processing method according to the present embodiment, and thereby sets, for example, an access state shown in FIG. 1 for each application. By setting an access state for each application, possibility of execution of the application is controlled according to the set access state. Thus, possibility of execution of the application that can be executed using communication with an external device becomes more flexible, and therefore, the information processing device according to the present embodiment can achieve enhancement of user convenience in executing the application.

### [2] Process of Information Processing Method According to Present Embodiment

Next, the process of the information processing method according to the present embodiment will be described.

### (1) State Control Process

The information processing device according to the present embodiment sets access states of an application for each application. Here, the access states that the information processing device according to the present embodiment sets through the state control process include the “authentication available state” as shown in A of FIG. 1 in which execution of an application based on the first communication and execution of the application based on the second communication are selectively permitted according to a communication state of the first communication.

The information processing device according to the present embodiment sets the access states of an application for each application by, for example, updating data in which the application is associated with the access states and stored, e.g., a table (or a database) in which an ID indicating the application is associated with IDs indicating the set access states and stored.

### (1-1) First Example of State Control Process

Based on a user operation, the information processing device according to the present embodiment sets an access state corresponding to the user operation for each application. As setting of an access state based on a user operation, for example, new setting of an access state, or changing of an access state that has already been set is exemplified.

The information processing device according to the present embodiment sets an access state indicated by an operation signal for each application based on, for example, an operation signal according to a user operation transferred from an operation unit (to be described below) provided in the information processing device according to the present embodiment, or an operation signal transmitted from an external operation device (for example, a device that plays a role of a remote controller) connected wirelessly or by wire with the information processing device according to the present embodiment.

In addition, the information processing device according to the present embodiment may cause, for example, a display screen of a display unit (to be described below) provided in the information processing device according to the present embodiment or a display screen of an external display device connected wirelessly or by wire with the information processing device according to the present embodiment to display a setting screen of an access state. Note that, when a display screen displayed on the setting screen is a display screen of a touch screen, the information processing device according to the present embodiment can set an access state indicated by an operation signal for each application based on the operation signal according to a user operation transferred from the touch screen.

When an access state of an application is set based on a user operation, the information processing device according to the present embodiment sets, for example, an arbitrary access state corresponding to a user operation for the application for which the access state is to be set (hereinafter referred to as a “setting target application”).

Note that a process for setting an access state based on a user operation according to the present embodiment is not limited to the above-described example.

For example, the information processing device according to the present embodiment does not set the authentication available state (A of FIG. 1) for a setting target application of an access state.

The information processing device according to the present embodiment does not allow a user to set the authentication available state (A of FIG. 1) for a setting target application by, for example, causing the authentication available state (A of FIG. 1) not to be displayed on an access state setting screen, or causing the authentication available state (A of FIG. 1) to be displayed but not to be selectable on the access state setting screen. In addition, when an access state corresponding to a user operation is the authentication available state (A of FIG. 1), for example, the information processing device according to the present embodiment does not set the authentication available state (A of FIG. 1) for an application by not setting the access state corresponding to the user operation.

In addition, when an access state set for a setting target application is the authentication available state (A of FIG. 1), the information processing device according to the present embodiment, for example, does not set an access state corresponding to a user operation for the setting target application.

The information processing device according to the present embodiment does not allow a user to set an access state for a setting target application by, for example, causing the access state setting screen not to be displayed, or causing the respective access states to be displayed but not to be selectable on the access state setting screen. In addition, even when a user operation for setting an access state has been performed, for example, the information processing device according to the present embodiment does not set the access state for an application by not setting the access state corresponding to the user operation.

When an access state of an application can be set based on a user operation, the information processing device according to the present embodiment restricts setting of the access state for the setting target application as described above, and thus, for example, it is possible to restrict changing of an access state by a third person who has acquired the lost or stolen information processing device according to the present embodiment. In addition, by restricting setting of an access state for a setting target application as described above, for example, prevention of use of the application by a third person and the like can be achieved.

### (1-2) Second Example of State Control Process

The information processing device according to the present embodiment sets an access state corresponding to an access state setting request transmitted from an external device for each application based on the access state setting request.

Here, as the external device that transmits the access state setting request, for example, a state control device according to the present embodiment to be described below is exemplified. The access state setting request is transmitted from the external device when a process for state control according to the present embodiment to be described below is performed.

In addition, the access state setting request according to the present embodiment includes, for example, data indicating a setting target application (for example, an ID indicating an application, etc.), data indicating an access state to be set (for example, an ID indicating an access state, data indicating the content of each access state shown in FIG. 1, etc.), and an access state setting command.

In addition, the access state setting request according to the present embodiment may include data indicating an external device that transmits the access state setting request (for example, identification information such as an ID or a Media Access Control (MAC) address of the device, etc.). When the access state setting request includes data indicating an external device, the information processing device according to the present embodiment, for example, authenticates the external device using the data indicating the external device. Then, when authentication is completed normally, the information processing device according to the present embodiment sets an access state corresponding to the access state setting request for a setting target application. In addition, when authentication is not completed normally, the information processing device according to the present embodiment does not set an access state corresponding to the access state setting request for the setting target application.

### (1-3) Third Example of State Control Process

The information processing device according to the present embodiment can also perform both processes of the state control process according to the first example shown in (1-1) described above and the state control process according to the second example shown in (1-2) described above as state control processes.

An access state of an application is set for each application, for example, when the information processing device according to the present embodiment performs any process of the state control process according to the first example shown in (1-1) described above to the state control process according to the third example shown in (1-3) described above.

Here, by setting an access state for each application, possibility of execution of the application is restricted according to the set access state. Thus, by performing the state control process, the information processing device according to the present embodiment can achieve enhancement of user convenience in executing the application.

Note that a process of the information processing method according to the present embodiment is not limited to the state control process. As a process of the information processing method according to the present embodiment, for example, the information processing device according to the present embodiment can further perform an execution process shown below.

### (2) Execution Process

The information processing device according to the present embodiment selectively executes an application to be executed (hereinafter referred to as an “execution target application”) according to a set access state, and performs a process corresponding to the executed application. As a process corresponding to the executed application, for example, an arbitrary process such as a process for payment or a process for authentication is exemplified.

As examples of selective execution of an application according to a set access state, for example, examples shown in (a) to (e) below are shown.

### (a) When Authentication Available State (a of FIG. 1) is Set for Execution Target Application

In the case of a connected state of the first communication, the information processing device according to the present embodiment executes an execution target application using the first communication and/or the second communication with an external device. In addition, in the case of an unconnected state of the first communication, the information processing device according to the present embodiment does not execute an execution target application using either of the first communication and the second communication with an external device.

(b) When all-Communication Available State (B of FIG. 1) is Set for Execution Target Application

The information processing device according to the present embodiment executes an execution target application using the first communication and/or the second communication with an external device.

### (c) When First Communication Available State (C of FIG. 1) is Set for Execution Target Application

The information processing device according to the present embodiment executes an execution target application using the first communication with an external device. In addition, the information processing device according to the present embodiment does not execute the execution target application using the second communication with the external device.

### (d) When Second Communication Available State (D of FIG. 1) is Set for Execution Target Application

The information processing device according to the present embodiment executes an execution target application using the second communication with an external device. In addition, the information processing device according to the present embodiment does not execute the execution target application using the first communication with the external device.

### (e) When Unavailable State (E of FIG. 1) is Set for Execution Target Application

The information processing device according to the present embodiment does not execute an execution target application using either of the first communication and the second communication with an external device.

As the process of the information processing method according to the present embodiment, for example, the information processing device according to the present embodiment executes “the process (state control process) described in (1) above” or “the process (state control process) described in (1) above and the process (execution process) described in (2) above.”

Note that “the process (state control process) described in (1) above” and “the process (state control process) described in (1) above and the process (execution process) described in (2) above” are processes divided from the process of the information processing method according to the present embodiment for the sake of convenience. Thus, with regard to the process of the information processing method according to the present embodiment, for example, “the process (state control process) described in (1) above and the process (execution process) described in (2) above” can be deemed one process. In addition, with regard to the process of the information processing method according to the present embodiment, for example, “the process (state control process) described in (1) above” and “the process (state control process) described in (1) above and the process (execution process) described in (2) above” can also be deemed two or more processes (using an arbitrary dividing method).

### [3] Specific Example of Process of Information Processing Method According to Present Embodiment

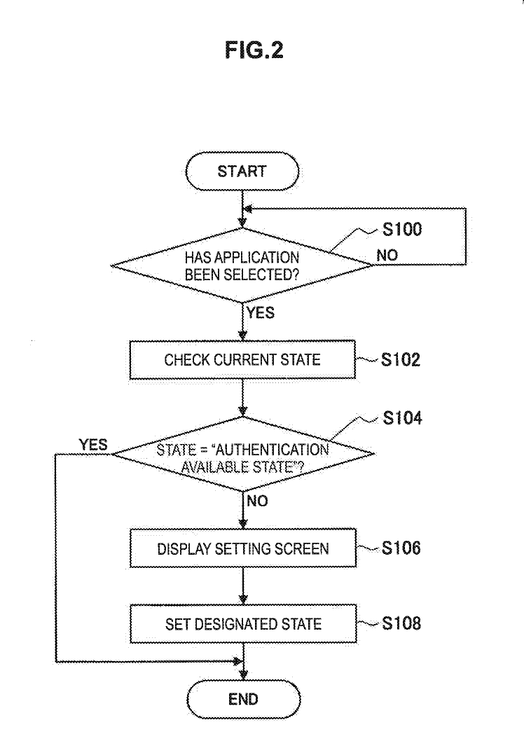

FIG. 2 is a flowchart showing an example of the process of the information processing method according to the present embodiment. Processes of Steps S100 to S108 shown in FIG. 2 correspond to an example of the process (state control process) shown in (1) above. In addition, FIG. 2 shows the example in which the information processing device according to the present embodiment performs the state control process according to the first example shown in (1-1) above, i.e., an example in which an access state is set for a setting target application based on a user operation.

The information processing device according to the present embodiment determines whether or not an application has been selected (S100). The information processing device according to the present embodiment determines whether or not an application has been selected based on, for example, an operation signal transferred from an operation unit (to be described below), or the like.

When no application is determined to have been selected in Step S100, the information processing device according to the present embodiment does not advance the process until an application is determined to have been selected.

In addition, when an application is determined to have been selected in Step S100, the information processing device according to the present embodiment checks a currently set access state of the application that is selected determined, i.e., a setting target application (S102). The information processing device according to the present embodiment checks the currently set access state for the setting target application by, for example, referring to a table in which an ID indicating the application is associated with an ID indicating the set access state and stored, or the like.

The information processing device according to the present embodiment determines whether or not the currently set access state for the setting target application is the authentication available state (A of FIG. 1) (S104).

When the currently set access state for the setting target application is determined to be the authentication available state (A of FIG. 1) in Step S104, the information processing device according to the present embodiment, for example, ends the process of the information processing method according to the present embodiment.

Here, when the currently set access state for the setting target application is determined to be the authentication available state (A of FIG. 1) in Step S104, the information processing device according to the present embodiment, for example, may notify a user that it is not possible to change the access state. The information processing device according to the present embodiment notifies the user that it is not possible to change the access state using an arbitrary method in which the user can be notified, for example, visual notification performed by displaying text or an image on a display screen, auditory notification performed by outputting a sound (including music) from an audio output device such as a speaker, notification performed by combining these, or the like.

In addition, when the currently set access state for the setting target application is determined not to be the authentication available state (A of FIG. 1) in Step S104, the information processing device according to the present embodiment causes a setting screen for setting an access state to be displayed on the display screen (S106). Then, the information processing device according to the present embodiment sets an access state designated by the user on the setting screen (an example of an access state corresponding to a user operation) for the setting target application (S108).

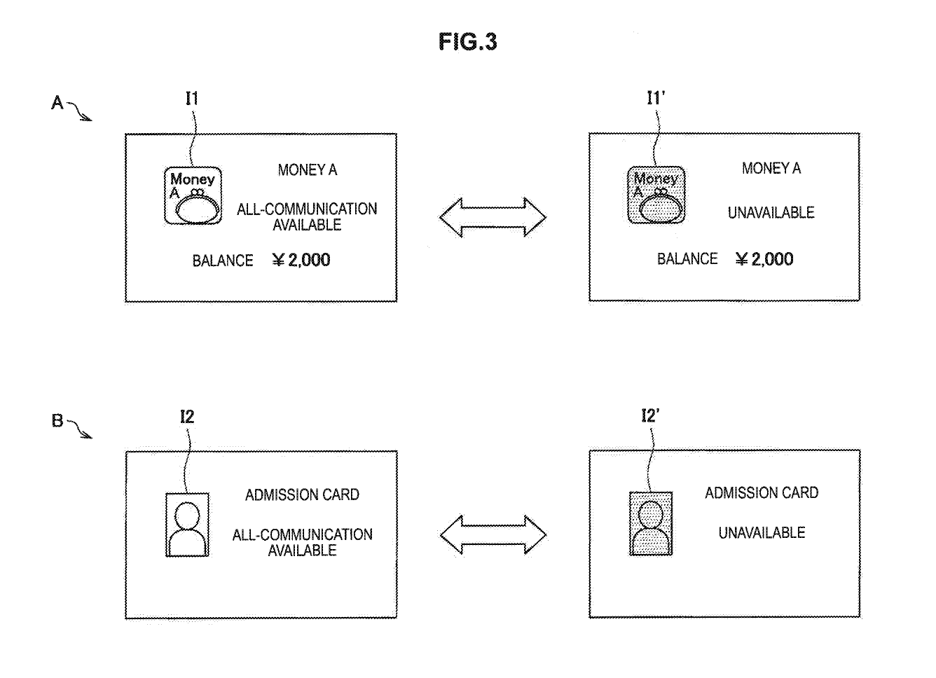

FIG. 3 is an illustrative diagram for describing an example of the process of the information processing method according to the present embodiment, showing examples of access states set through the process of the information processing 6 method according to the present embodiment.

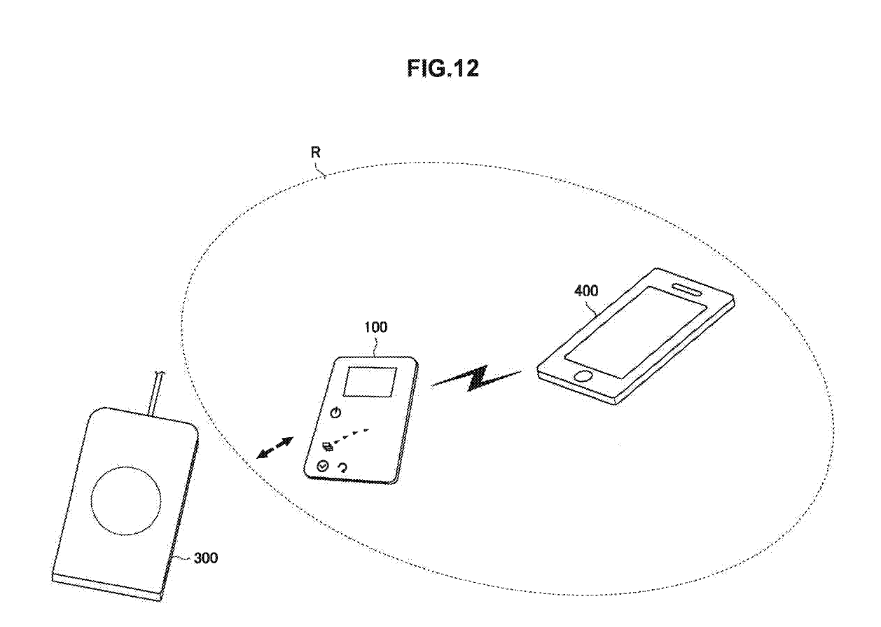

A of FIG. 3 shows an example of an access state set for an application that performs a process for electronic money A. In addition, B of FIG. 3 shows an example of an access state set for an application that performs a process for an admission card. As indicated by 11 and 11′ shown in A of FIGS. 3 and 12 and 12′ shown in B of FIG. 3, for example, icons indicating applications may change according to an access state set for each of the applications. In addition, a font, a layout, or the like of letters may be changed according to an access state set for each of the applications.

The information processing device according to the present embodiment performs, for example, the process shown in FIG. 2 as the process of the information processing method according to the present embodiment.

Note that a process of the information processing method according to the present embodiment is not limited to the example shown in FIG. 2. The information processing device according to the present embodiment may not perform, for example, the process of Step S104.

### (State Control Method According to Present Embodiment)

The information processing device according to the present embodiment can set an access state for each application based on an access state setting request transmitted from an external device, as described above. Thus, a state control method according to the present embodiment which enables the information processing device according to the present embodiment to set an access state will be described next. The state control method according to the present embodiment will be described below exemplifying a case in which the state control device according to the present embodiment performs a process of the state control method according to the present embodiment.

The state control device according to the present embodiment causes an external device to set an access state of an application (the state control process).

The state control device according to the present embodiment generates an access state setting request for setting an access state corresponding to a user operation based on, for example, the user operation of a user of the state control device according to the present embodiment. Then, the state control device according to the present embodiment causes, for example, a communication device provided in the state control device according to the present embodiment or an external communication device connected to the state control device according to the present embodiment to transmit the generated access state setting request to the external device, and thereby causes the external device to set an access state. As setting of an access state by the external device based on the user operation, for example, new setting of an access state in the external device, or changing of an access state already set in the external device is exemplified.

Based on, for example, an operation signal according to a user operation transferred from an operation unit (to be described below) provided in the state control device according to the present embodiment, or an operation signal transmitted from an external operation device (for example, a device playing a role of a remote controller) connected wirelessly or by wire to the state control device according to the present embodiment, the state control device according to the present embodiment generates an access state setting request for setting an access state indicated by the operation signal. In addition, the state control device according to the present embodiment may cause a setting control screen of an access state to be displayed on, for example, a display screen of a display unit (to be described below) provided in the state control device according to the present embodiment, or a display screen of an external display device connected wirelessly or by wire to the state control device according to the present embodiment.

Here, as an external device which is caused to set an access state by the state control device according to the present embodiment, for example, a device which can perform the process of the information processing method according to the present embodiment, e.g., the information processing device according to the present embodiment, is exemplified. A case in which an external device which is caused to set an access state by the state control device according to the present embodiment is the information processing device according to the present embodiment will be exemplified below.

In addition, as access states that the state control device according to the present embodiment can cause an external device to set through the state control process, the access states shown in FIG. 1 are exemplified. That is, the access states that the state control device according to the present embodiment can cause an external device to set through the state control process include the “authentication available state” as shown in A of FIG. 1 in which execution of an application based on the first communication and execution of the application based on the second communication are selectively permitted according to a communication state of the first communication.

As the state control device according to the present embodiment causes an external device such as the information processing device according to the present embodiment to set an access state of an application, possibility of execution of each application is controlled according to the set access state in the external device.

Thus, as the state control device according to the present embodiment causes the external device to set an access state of an application, enhancement of user convenience in executing the application can be achieved.

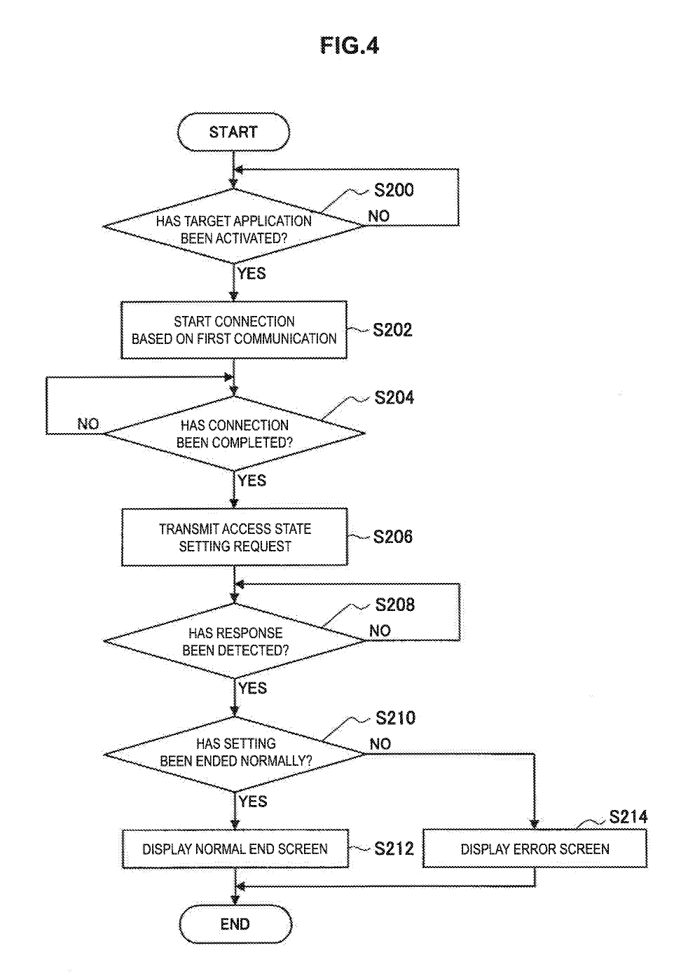

FIG. 4 is a flowchart showing an example of the process of the state control method according to the present embodiment. FIG. 4 shows the example in which the state control device according to the present embodiment causes the information processing device according to the present embodiment to set an access state via the first communication.

The state control device according to the present embodiment determines whether or not a target application for which an access state is to be set has been activated (S200). The target application is activated when it is executed based on, for example, a user operation of a user of the state control device according to the present embodiment.

When the target application is determined not to have been activated in Step S200, the state control device according to the present embodiment does not advance the process until the target application is determined to have been activated.

In addition, when the target application is determined to have been activated in Step S200, the state control device according to the present embodiment starts the first communication with the information processing device according to the present embodiment (S202). Then, the state control device according to the present embodiment determines whether or not connection based on the first communication has been completed and thus the first communication with the information processing device according to the present embodiment has become possible (S204).

When connection based on the first communication is determined not to have been completed in Step S204, the state control device according to the present embodiment does not advance the process until connection based on the first communication is determined to have been completed.

In addition, when connection based on the first communication is determined to have been completed in Step S204, the state control device according to the present embodiment transmits an access state setting request to the information processing device according to the present embodiment using the first communication (S206). The state control device according to the present embodiment, for example, causes a setting control screen of an access state to be displayed on a display screen, and thereby causes an access state setting request for setting an access state corresponding to a user operation performed on the setting control screen to be transmitted.

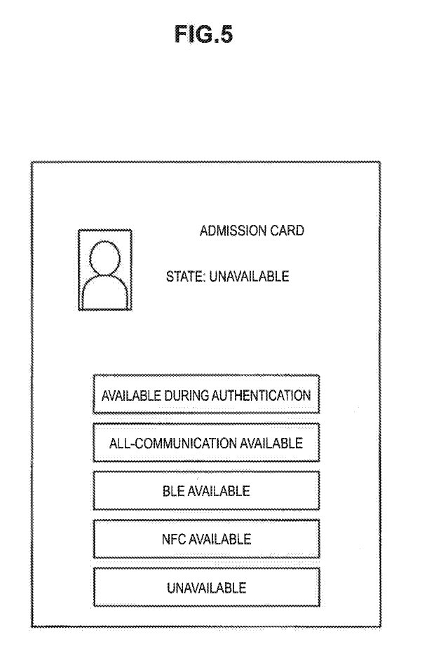

FIG. 5 is an illustrative diagram showing an example of the setting control screen according to the present embodiment, showing the example of the setting control screen for setting an access state for an application (an example of the setting target application) that performs a process for an admission card.

The setting control screen according to the present embodiment displays buttons for setting access states each corresponding to, for example, the authentication available state (which corresponds to “available during authentication” of FIG. 5), the all-communication available state (which corresponds to “all-communication available” of FIG. 5), the first communication available state (which corresponds to “BLE available” of FIG. 5), the second communication available state (which corresponds to “NFC available” of FIG. 5), and the unavailable state (which corresponds to “unavailable” of FIG. 5).

In addition, the setting control screen according to the present embodiment displays a currently set access state (which corresponds to “state: unavailable” shown in FIG. 5) for the setting target application. As a currently set access state for the setting target application displayed on the setting control screen according to the present embodiment, an access state associated with the setting target application managed in a table or the like by the state control device according to the present embodiment is exemplified. In addition, the currently set access state for the setting target application displayed on the setting control screen according to the present embodiment may be an access state associated with the setting target application of the information processing device according to the present embodiment acquired from the information processing device according to the present embodiment via the first communication.

Based on, for example, a user operation performed on the setting control screen as shown in FIG. 5, the state control device according to the present embodiment generates an access state setting request for setting an access state selected through the user operation. Then, the state control device according to the present embodiment transmits the generated access state setting request.

Note that it is a matter of course that the setting control screen according to the present embodiment is not limited to the example shown in FIG. 5.

The example of the process of the state control method according to the present embodiment will be described with reference to FIG. 4 again. When the access state setting request is transmitted to the information processing device according to the present embodiment in Step S206, the state control device according to the present embodiment determines whether or not a response of the information processing device according to the present embodiment to the access state setting request has been detected (S208).

When no response is determined to have been detected in Step S208, the state control device according to the present embodiment does not advance the process until a response is determined to have been detected. Note that, when no response to the access state setting request is detected after the access state setting request is transmitted in Step S206 and a set predetermined period of time elapses, the state control device according to the present embodiment may end the process of the state control method according to the present embodiment (so-called time-out).

In addition, when a response is determined to have been detected in Step S208, the state control device according to the present embodiment determines whether or not the information processing device according to the present embodiment has ended setting of an access state according to the access state setting request normally (S210). The state control device according to the present embodiment determines the setting as being ended normally when the response detected in Step S208 indicates that the setting of the access state has ended normally.

When the setting of the access state is determined to have ended normally in Step S210, the state control device according to the present embodiment causes the display screen to display a normal end screen indicating that the setting of the access state has ended normally (S212). In addition, when the setting of the access state is determined not to have ended normally in Step S210, the state control device according to the present embodiment causes the display screen to display an error screen (S214).

The state control device according to the present embodiment performs the process shown in FIG. 4, for example, as the process of the state control method according to the present embodiment.

Note that the process of the state control method according to the present embodiment is not limited to the example shown in FIG. 4. For example, although FIG. 4 shows the example in which the state control device according to the present embodiment causes the information processing device according to the present embodiment to set an access state through the first communication, the state control device according to the present embodiment can also cause the information processing device according to the present embodiment to set an access state via the second communication.

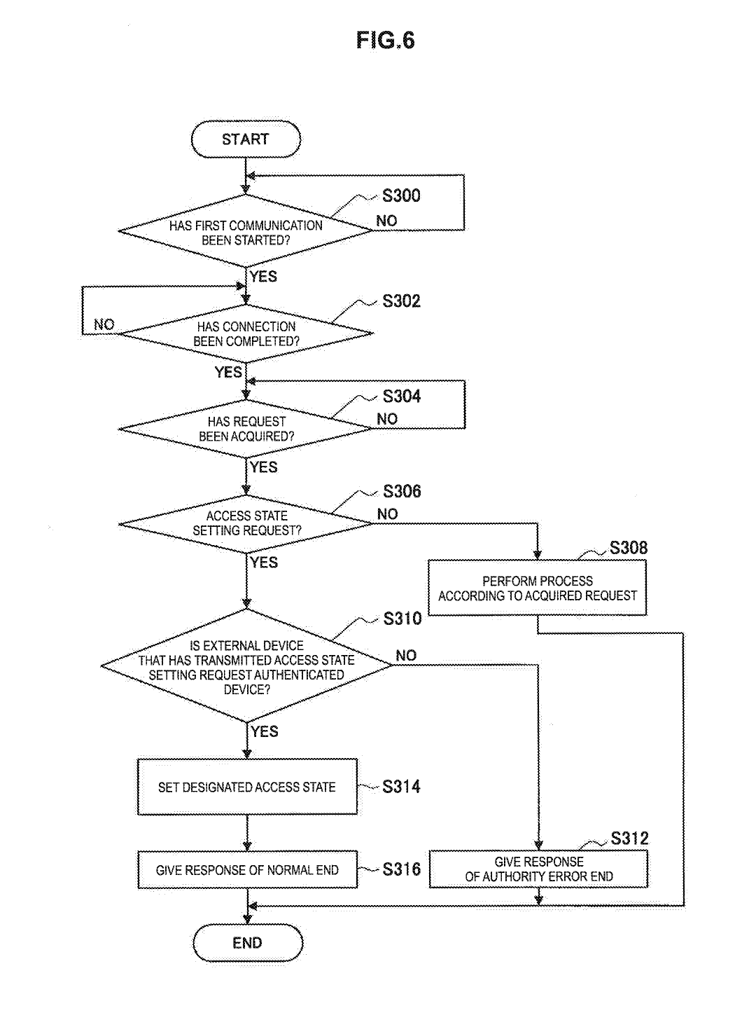

FIG. 6 is a flowchart showing another example of the process of the information processing method according to the present embodiment. Processes of Step S300 to S316 shown in FIG. 6 correspond to an example of the process (state control process) described in (1) above.

In addition, FIG. 6 shows an example in which the information processing device according to the present embodiment performs the state control process according to the second example shown in (1-2) above, i.e., an example in which an access state is set for a setting target application based on an access state setting request transmitted from the state control device according to the present embodiment (an example of an external device). In addition, FIG. 6 shows an example in which the information processing device according to the present embodiment sets an access state for the setting target application based on the access state setting request acquired via the first communication.

The information processing device according to the present embodiment determines whether or not the first communication with the state control device according to the present embodiment has started (S300). When the first communication is determined not to have started in Step S300, the information processing device according to the present embodiment does not advance the process until the first communication is determined to have started.

In addition, when the first communication is determined to have started in Step S300, the information processing device according to the present embodiment determines whether or not connection based on the first communication has been completed, and thus the first communication with the state control device according to the present embodiment is possible (S302). Here, the information processing device according to the present embodiment may authenticate a communication target device at the time of connection based on the first communication. When the first communication is BLE, for example, the information processing device according to the present embodiment authenticates the communication target device using a MAC address, or the like.

When connection based on the first communication is determined not to have been completed in Step S302, the information processing device according to the present embodiment does not advance the process until connection based on the first communication is determined to have been completed.

In addition, when connection based on the first communication is determined to have been completed in Step S302, the information processing device according to the present embodiment determines whether or not a request has been acquired via the first communication (S304).

When no request is determined to have been acquired in Step S304, the information processing device according to the present embodiment does not advance the process until a request is determined to have been acquired.

In addition, when a request is determined to have been acquired in Step S304, the information processing device according to the present embodiment determines whether or not the acquired request is an access state setting request (S306). The information processing device according to the present embodiment performs the determination of Step S306 based on, for example, data included in the acquired request, such as a command included in the acquired request.

When the acquired request is determined not to be an access state setting request in Step S306, the information processing device according to the present embodiment performs a process according to the acquired request (S308).

In addition, when the acquired request is determined to be an access state setting request in Step S306, the information processing device according to the present embodiment determines whether or not the external device that has transmitted the access state setting request is an authenticated device (S310). The information processing device according to the present embodiment performs the determination of Step S310 based on, for example, data used in authentication at the time of the connection based on the first communication, such as the MAC address, or the like.

When the device is determined not to be an authenticated device in Step S310, the information processing device according to the present embodiment does not perform a process according to the access state setting request, and gives a response that a process according to the access state setting request is not performed due to an authority error via the first communication (S312).

In addition, when the device is determined to be an authenticated device in Step S310, the information processing device according to the present embodiment sets an access state corresponding to the access state setting request for the setting target application corresponding to the access state setting request (S314). Then, the information processing device according to the present embodiment gives a response that the access state corresponding to the access state setting request has been set normally via the first communication (S316).

When an access state is set based on an access state setting request transmitted from the state control device according to the present embodiment, the information processing device according to the present embodiment performs the process shown in FIG. 6, for example, as the process of the information processing method according to the present embodiment.

Note that the process of the information processing method according to the present embodiment performed when an access state is set based on an access state setting request transmitted from the state control device according to the present embodiment is not limited to the example shown in FIG. 6.

For example, although FIG. 6 shows the example in which the information processing device according to the present embodiment sets an access state based on an access state setting request acquired via the first communication, the information processing device according to the present embodiment can also set an access state based on an access state setting request acquired via the second communication.

In addition, when the setting of the access state corresponding to the access state setting request of Step S314 has not been completed normally, the information processing device according to the present embodiment may give a response that the setting of the access state has not been completed normally.

### (Information Processing Device and State Control Device According to Present Embodiment)

Next, a configuration of the information processing device according to the present embodiment that can perform the process of the information processing method according to the present embodiment and a configuration of the state control device according to the present embodiment that can perform the process of the state control method according to the present embodiment will be described.

A case in which the second communication is NFC and the first communication is communication of another communication scheme that is different from NFC will be mainly exemplified. Note that the first communication may be NFC and the second communication may be communication of another communication scheme that is different from NFC as described above.

### [1] Information Processing Device According to Embodiment

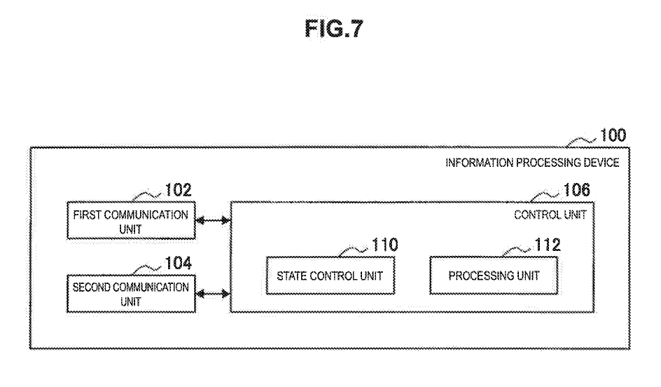

FIG. 7 is a block diagram showing an example of the configuration of the information processing device 100 according to the present embodiment. The information processing device 100 has, for example, a first communication unit 102, a second communication unit 104, and a control unit 106.

In addition, the information processing device 100 may have, for example, a read only memory (ROM, which is not shown), a random access memory (RAM, which is not shown), a storage unit (not shown), an operation unit (not shown) which can be operated by a user, a display unit (not shown) that displays various screens such as a screen as shown in FIG. 3 on a display screen, or the like. The information processing device 100 connects the respective constituent elements with each other using, for example, a bus serving as a data transmission path.

The ROM (not shown) stores data for control, such as programs and operation parameters to be used by the control unit 106. The RAM (not shown) temporarily stores a program executed by the control unit 106 or the like.

The storage unit (not shown) is a storage means provided in the information processing device 100, and stores various kinds of data, for example, data relating to the information processing method according to the present embodiment such as a table (or a database) in which IDs indicating applications are associated with IDs indicating set access states and stored, or various applications. Here, as the storage unit (not shown), for example, a magnetic recording medium such as a hard disk, a non-volatile memory such as a flash memory, or the like is exemplified. In addition, the storage unit (not shown) may be attachable to/detachable from the information processing device 100.

As the operation unit (not shown), an operation input device which will be described below may be exemplified. As the display unit (not shown), a display device which will be described below may be exemplified.

### [Example of Hardware Configuration of Information Processing Device 100]

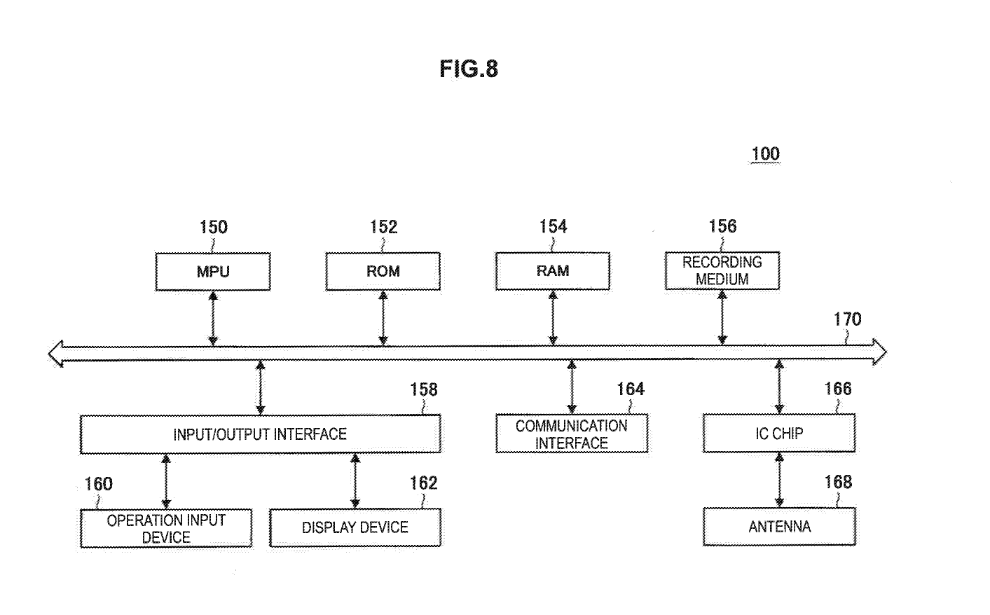

FIG. 8 is an illustrative diagram showing an example of a hardware configuration of the information processing device 100 according to the present embodiment.

The information processing device 100 includes, for example, an MPU 150, a ROM 152, a RAM 154, a recording medium 156, an input/output interface 158, an operation input device 160, a display device 162, a communication interface 164, an IC chip 166 and an antenna 168. In addition, the information processing device 100 connects the components, for example, by means of a bus 170 as a data transmission path.

The MPU 150 is composed of one or more processors configured as operation circuits such as a micro-processing unit (MPU) and various processing circuits and functions as the control unit 106 that controls the information processing device 100. In addition, the MPU 150 serves as, for example, a state control unit 110 and a processing unit 112 which will be described below, in the information processing device 100.

The ROM 152 stores data for control, such as programs and operation parameters to be used by the MPU 150, and the like. The RAM 154 temporarily stores, for example, a program or the like executed by the MPU 150.

The recording medium 156 functions as the storage unit (not shown) and stores, for example, data relating to the information processing method according to the present embodiment and data such as various applications. Here, as the recording medium 156, for example, a magnetic recording medium such as a hard disk or a non-volatile memory such as a flash memory may be exemplified. Furthermore, the recording medium 156 may be attachable to/detachable from the information processing device 100.

The input/output interface 158 is connected, for example, to the operation input device 160 and the display device 162. The operation input device 160 serves as the operation unit (not shown) and the display device 162 serves as the display unit (not shown). Here, as the input/output interface 158, for example, a Universal Serial Bus (USB) port, a digital visual interface (DVI) terminal, a high-definition multimedia interface (HDMI) (registered trademark) terminal, various processing circuits or the like may be exemplified.

In addition, the operation input device 160 is, for example, included in the information processing device 100 and connected to the input/output interface 158 inside the information processing device 100. As the operation input device 160, for example, a button, arrow keys, a rotary type selector such as a jog dial or a combination thereof may be exemplified.

Furthermore, the display device 162 is, for example, included in the information processing device 100 and connected to the input/output interface 158 inside the information processing device 100. As the display device 162, for example, a liquid crystal display, an organic electro-luminescence display (which is also referred to as an organic light emitting diode (OLED) display) or the like may be exemplified.

Of course, the input/output interface 158 may be connected to an external device such as an external operation input device (e.g., a keyboard, a mouse, etc.) and an external display device as external devices of the information processing device 100. Furthermore, the display device 162 may be, for example, a device that enables display and a user operation, such as a touch screen.

The communication interface 164 is a communication means provided in the information processing device 100 to perform communication. The communication interface 164 functions as, for example, the first communication unit 102 that performs communication based on the first communication. Note that the information processing device 100 may have a configuration in which, for example, the communication interface 164 functions as the second communication unit 104 that performs communication based on the second communication. The communication interface 164 communicates with an external device, for example, a state control device 200 or the like via a network (or directly).

Here, as the communication interface 164, for example, an IEEE 802.15.1 port and a transmission/reception circuit, an IEEE 802.11 port and a transmission/reception circuit, a LAN terminal and a transmission/reception circuit, or the like are exemplified.

The IC chip 166 and the antenna 168 are other communication means provided in the information processing device 100 to perform communication. The IC chip 166 and the antenna 168 function as, for example, the second communication unit 104 that performs communication based on the second communication. Note that the information processing device 100 may have a configuration in which, for example, the IC chip 166 and the antenna 168 function as the first communication unit 102 that performs communication based on the first communication.

The IC chip 166 and the antenna 168 perform communication with a reader-writer or an external device having a reader-writer function based on NFC using, for example, a carrier of a predetermined frequency, such as 13.56 [MHz]. The antenna 168 plays a role of receiving carriers and transmitting response signals. In addition, the IC chip 166 demodulates and processes carrier signals transmitted from an external device such as a reader-writer based on received carriers, and causes response signals to be transmitted using load modulation.

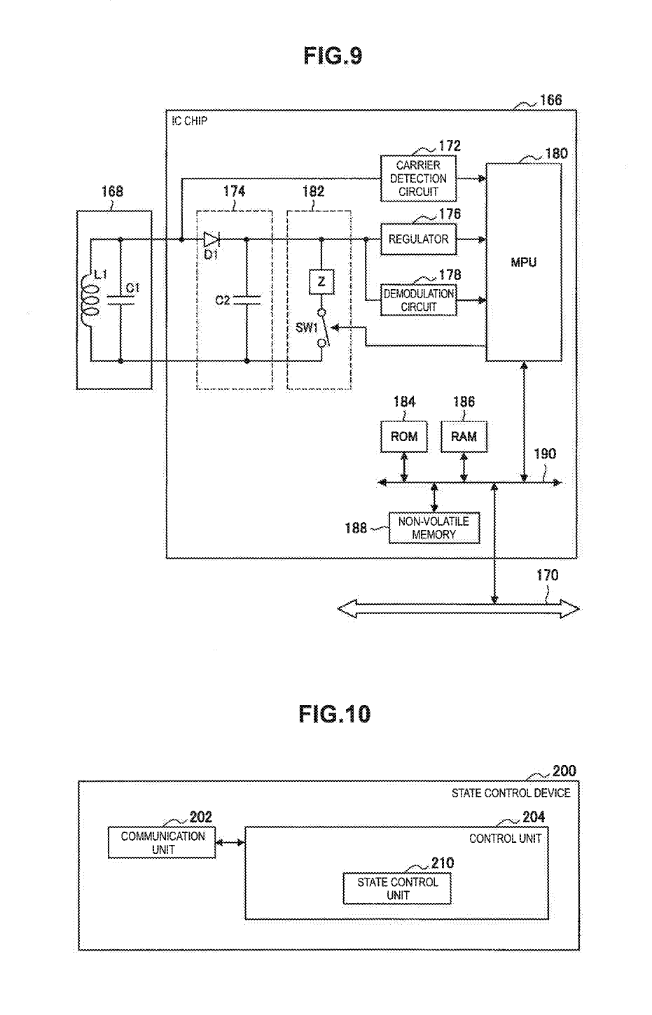

FIG. 9 is an illustrative diagram showing an example of a configuration of the IC chip 166 and the antenna 168 shown in FIG. 8. Note that the information processing device 100 may not have the configuration of the IC chip 166 shown in FIG. 9 in, for example, a form of an IC chip.

The antenna 168 is configured as, for example, a resonance circuit constituted by a coil L1 having a predetermined inductance (an inductor) and a capacitor C1 having a predetermined electrostatic capacitance, and generates an induced voltage through electromagnetic induction according to reception of carriers. Then, the antenna 168 outputs a reception voltage obtained by causing the induced voltage to resonate at a predetermined resonance frequency. Here, the resonance frequency of the antenna 168 is set according to a frequency of a carrier, for example, 13.56 [MHz]. The antenna 168 receives carriers using the above-described configuration, and performs transmission of response signals using load modulation performed by a load modulation circuit 182 that the IC chip 166 has.

The IC chip 166 has a carrier detection circuit 172, a detector circuit 174, a regulator 176, a demodulation circuit 178, an MPU 180, and a load modulation circuit 182. Note that, although not shown in FIG. 9, the IC chip 166 may further have, for example, a protection circuit (not shown) which prevents overvoltage or overcurrent to be applied to the MPU 160. Here, as the protection circuit (not shown), for example, a clamper configured with a diode or the like is exemplified.

In addition, the IC chip 166 has, for example, a ROM 184, a RAM 186, and a non-volatile memory 188. The MPU 180, the ROM 184, the RAM 186, and the non-volatile memory 188 are connected to each other by, for example, a bus 190 serving as a data transmission path. Furthermore, the bus 190 is connected to the bus 170.

Then ROM 184 stores programs to be used by the MPU 180 and control data such as operation parameters. The RAM 186 temporarily stores programs executed by the MPU 180, results of arithmetic operations, states of execution, and the like.

The non-volatile memory 188 stores various kinds of data, for example, electronic values (money or data having values equivalent to money), various applications, data corresponding to applications, and the like. Here, as the non-volatile memory 188, for example, an electrically erasable and programmable read only memory (EEPROM), a flash memory, or the like is exemplified. In addition, the non-volatile memory 188 may have, for example, tampering resistance.

The carrier detection circuit 172 generates, for example, a rectangular detection signal based on a reception voltage delivered from the antenna 168, and delivers the detection signal to the MPU 180. In addition, the MPU 180 uses the delivered detection signal as, for example, a processing clock for data processing. Here, since the detection signal is based on the reception voltage delivered from the antenna 168, it is synchronized with the frequency of a carrier transmitted from an external device such as a reader/writer. Thus, with the carrier detection circuit 172 provided, the IC chip 166 can perform a process with an external device such as a reader/writer in synchronization with the external device.

The detector circuit 174 commutates the reception voltage output from the antenna 168. Here, the detector circuit 174 is constituted by, for example, a diode DI and a capacitor C2.

The regulator 176 smoothly turns the reception voltage into a constant voltage to output a drive voltage to the MPU 180. Here, the regulator 176 uses DC components of the reception voltage as the drive voltage.

The demodulation circuit 178 demodulates a carrier signal based on the reception voltage, and outputs data corresponding to the carrier signal included in the carrier (for example, a data signal binarized to a high level and a low level). Here, the demodulation circuit 178 outputs AC components of the reception voltage as data.

The MPU 180 is driven using the drive voltage output from the regulator 176 as a power source, and performs processes of the data demodulated by the demodulation circuit 178. Here, the MPU 180 is constituted by, for example, one or two or more processors configured as an operation circuit such as an MPU, various processing circuits, and the like.

In addition, the MPU 180 selectively generates a control signal for controlling load modulation relating to a response to an external device such as a reader/writer according to a process result. Then, the MPU 180 selectively outputs the control signal to the load modulation circuit 182.

The load modulation circuit 182 is provided with, for example, a load Z and a switch SW1, and performs load modulation by selectively connecting (activating) the load Z according to a control signal delivered from the MPU 180. Here, the load Z is configured with, for example, a resistance having a predetermined resistance value. In addition, the switch SW1 is configured with, for example, a p-channel metal oxide semiconductor field effect transistor (MOSFET), or an n-channel MOSFET.

With the configuration described above, the IC chip 166 can process the carrier signal received by the antenna 168, and cause the antenna 168 to transmit a response signal using load modulation.

Since the IC chip 166 and the antenna 168 have the configuration shown in FIG. 9, for example, they perform communication with an external device such as a reader/writer based on NFC using a carrier having a predetermined frequency. Note that it is a matter of course that a configuration of the IC chip 166 and the antenna 168 according to the present embodiment is not limited to the example shown in FIG. 9.

With the configuration shown in FIG. 8, for example, the information processing device 100 performs the process of the information processing method according to the present embodiment described above. Note that a hardware configuration of the information processing device 100 according to the present embodiment is not limited to the configuration shown in FIG. 8.

The information processing device 100 may not be provided with, for example, the communication interface 164 when the device performs the first communication (or the second communication with an external device via a connected external communication device.

In addition, the information processing device 100 may be further provided with, for example, a carrier transmission circuit that is electrically connected with the antenna 168. As the carrier transmission circuit, for example, a modulation circuit that performs modulation such as Amplitude Shift Keying (ASK) and an amplification circuit that amplifies output of the modulation circuit are exemplified. With the carrier transmission circuit provided, the information processing device 100 has a function of an initiator for NFC and plays a role of a so-called reader/writer.

In addition, when the second communication (or the first communication) is not NFC, the information processing device 100 may not be provided with the IC chip 166 and the antenna 168. Furthermore, when the second communication (or the first communication) is not NFC, the information processing device 100 is further provided with, for example, a communication device of a communication scheme different from the communication interface 164 such as an infrared communication device, i.e., a communication device corresponding to the second communication (or the first communication).

In addition, when the second communication (or the first communication) with an external device is performed via a connected external communication device that can perform communication based on the second communication (or the first communication), the information processing device 100 may not be provided with a communication device corresponding to the second communication (or the first communication), such as the IC chip 166 and the antenna 168.

Further, the information processing device 100 may be further provided with other communication devices, for example, a communication antenna such as an antenna for LTE/3G and a radio frequency (RF) circuit, or the like. In addition, the information processing device 100 may be further provided with sensors, for example, a GPS sensor and an acceleration sensor.

In addition, the information processing device 100 may not be provided with one or two or more elements among, for example, the recording medium 156, the operation input device 160, and the display device 162. Note that, when an external display device is connected to the information processing device 100, for example, the information processing device 100 can cause the external display device to display a screen as shown in FIG. 3, regardless of whether the display device 162 is provided.

Further, the information processing device 100 may be further provided with, for example, an audio output device that outputs sounds (including music). As the audio output device according to the present embodiment, for example, a speaker is exemplified. In addition, the audio output device according to the present embodiment may further have a digital signal processor (DSP) that processes audio signals, an amplifier that amplifies audio signals, and the like.

When an audio output device is provided, the information processing device 100 causes the audio output device to output, for example, various sounds (including music) such as a sound (including music) relating to setting of access information for a setting target application. Here, as a sound relating to setting of access information for a setting target application, a sound indicating a setting result of access information for a setting target application, a sound indicating the content of access information set for a setting target application, or the like is exemplified. Note that, when an external audio output device is connected with the information processing device 100, for example, the information processing device 100 can cause the external audio output device to output sounds (including music), regardless of whether an audio output device is provided therein.

In addition, the configuration shown in FIG. 8 (or a configuration according to a modified example thereof) may be realized with, for example, one or two or more integrated circuits (ICs).

The example of the configuration of the information processing device 100 will be described with reference to FIG. 7 again. The first communication unit 102 communicates with external devices using the first communication. The first communication of the first communication unit 102 is controlled by, for example, the control unit 106.

Here, as the first communication unit 102, for example, an IEEE 802.15.1 port and a transmission/reception circuit, an IEEE 802.11 port and a transmission/reception circuit, a LAN terminal and a transmission/reception circuit, an infrared communication device, or the like are exemplified. In addition, when the second communication is not NFC, the first communication unit 102 may be an NFC-enabled communication device such as the IC chip 166 and the antenna 168 shown in FIG. 17.

The second communication unit 104 performs communication with external devices using the second communication whose communication scheme is different from that of the first communication. The second communication of the second communication unit 104 is controlled by, for example, the control unit 106.

Here, as the second communication unit 104, for example, NFC-enabled communication devices such as the IC chip 166 and the antenna 168 shown in FIG. 8 are exemplified. In addition, the second communication unit 104 may be an IEEE 802.15.1 port and a transmission/reception circuit, an IEEE 802.11 port and a transmission/reception circuit, a LAN terminal and a transmission/reception circuit, an infrared communication device, or the like as long as its communication scheme is different from that of the first communication.

The control unit 106 is constituted by, for example, an MPU, and the like, and plays a role in controlling the information processing device 100 overall. The control unit 106 is provided with, for example, a state control unit 110 and a processing unit 112, and plays a leading role in performing the process of the information processing method according to the present embodiment.

The state control unit 110 plays a leading role in performing the process (state control process) described in (1) above, and sets an access state for each application. The state control unit 110 performs, for example, any process of the state control process according to the first example described in (1-1) above to the state control process according to the third example described in (1-3) above, and thereby sets an access state for a setting target application.

The processing unit 112 plays a leading role in performing the process (execution process) described in (2) above, selectively executes an execution target application according to a set access state, and then performs a process corresponding to the executed application.

Since, for example, the state control unit 110 and the processing unit 112 are provided, the control unit 106 actively performs the process of the information processing method according to the present embodiment.

With the configuration shown in FIG. 7, for example, the information processing device 100 performs the process of the information processing method according to the present embodiment (for example, the process (state control process) described in (1) above and the process (execution process) described in (2) above).

Therefore, the information processing device 100 can achieve enhancement of user convenience in executing an application with, for example, the configuration shown in FIG. 7.

In addition, with the configuration shown in FIG. 7, for example, the information processing device 100 can exhibit effects obtained by performing, for example, the process of the information processing method according to the present embodiment as described above.

Note that a configuration of the information processing device according to the present embodiment is not limited to the configuration shown in FIG. 7.

The information processing device according to the present embodiment, for example, can employ a configuration in which the processing unit 112 shown in FIG. 7 is not provided.

Even when the configuration in which the processing unit 112 is not provided is employed, the information processing device according to the present embodiment can set an access state for each application through the process (state control process) described in (1) above. Thus, even when the configuration in which the processing unit 112 is not provided is employed, the information processing device according to the present embodiment can achieve enhancement of user convenience in executing an application.

In addition, the information processing device according to the present embodiment can be provided with, for example, either the state control unit 110 or the processing unit 112 shown in FIG. 7, or both, separately from the control unit 106 (for example, realized in a different processing circuit).

In addition, the process (state control process) described in (1) above and the process (execution process) described in (2) above are processes divided from the process of the information processing method according to the present embodiment for the sake of convenience as described above. Thus, a configuration for realizing the process of the information processing method according to the present embodiment is not limited to the state control unit 110 and the processing unit 112 shown in FIG. 7, and a configuration according to the dividing method of the process of the information processing method according to the present embodiment can be employed.

In addition, for example, when communication is performed with an external device via an external communication device having a function and configuration similar to those of the first communication unit 102, the information processing device according to the present embodiment may not be provided with the first communication unit 102.

Furthermore, for example, when communication is performed with an external device via an external communication device having a function and configuration similar to those of the second communication unit 104, the information processing device according to the present embodiment may not be provided with the second communication unit 104.

### [II] State Control Device 200

FIG. 10 is a block diagram showing an example of a configuration of the state control device 200 according to the present embodiment. The state control device 200 is provided with, for example, a communication unit 202 and a control unit 204.

In addition, the state control device 200 may be provided with, for example, a ROM (not shown), a RAM (not shown), a storage unit (not shown), an operation unit that a user can operate (not shown), a display unit that displays various screens such as the screen shown in FIG. 5 on a display screen (not shown), and the like. The state control device 200 connects the respective constituent elements with each other using, for example, a bus serving as a data transmission path.

The ROM (not shown) stores control data, such as programs and operation parameters used by the control unit 204. The RAM (not shown) temporarily stores a program executed by the control unit 204, and the like.

The storage unit (not shown) is a storage means provided in the state control device 200, and stores various kinds of data, for example, data relating to the state control method according to the present embodiment such as a table (or a database) in which applications are associated with currently set access states and stored, or various applications. Here, as the storage unit (not shown), for example, a magnetic recording medium such as a hard disk, a non-volatile memory such as a flash memory, or the like is exemplified. In addition, the storage unit (not shown) may be attachable to/detachable from the state control device 200.

As the operation unit (not shown), an operation input device which will be described below is exemplified. In addition, as the display unit (not shown), a display device which will be described below is exemplified.

### [Example of Hardware Configuration of State Control Device 200]

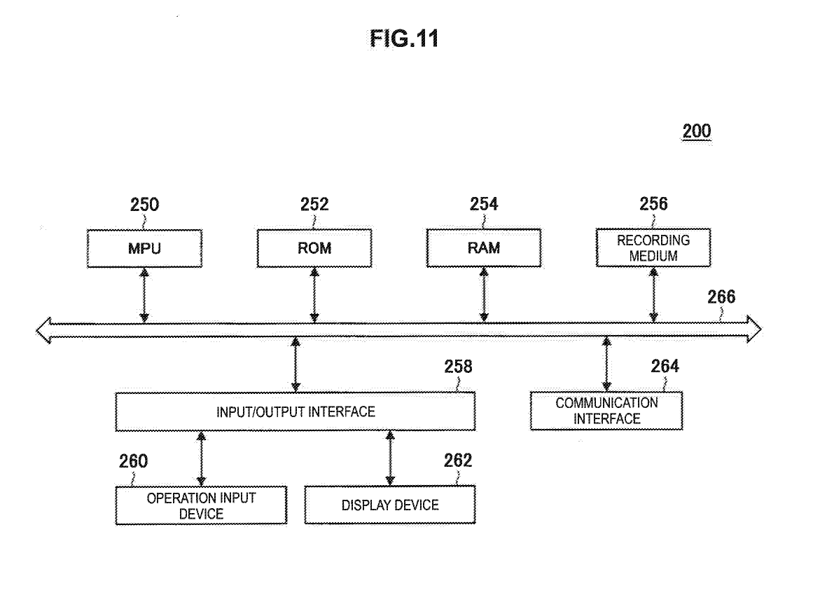

FIG. 11 is an illustrative diagram showing an example of a hardware configuration of the state control device 200 according to the present embodiment.

The state control device 200 is provided with, for example, an MPU 250, a ROM 252, a RAM 254, a recording medium 256, an input/output interface 258, an operation input device 260, a display device 262, and a communication interface 264. In addition, the state control device 200 connects the respective constituent elements with each other using, for example, a bus 266 serving as a data transmission path.

The MPU 250 is configured as, for example, an operation circuit such as an MPU, constituted by one or two or more processors, various processing circuits, and the like, and functions as the control unit 204 that controls the state control device 200 overall. In addition, the MPU 250 plays a role of, for example, a state control unit 210 to be described below in the state control device 200.

The ROM 252 stores control data such as programs and operation parameters used by the MPU 250, and the like. The RAM 254 temporarily stores, for example, programs executed by the MPU 250, and the like.

The recording medium 256 functions as the storage unit (not shown), and stores various kinds of data, for example, data relating to the state control method according to the present embodiment, or various applications. Here, as the recording medium 256, for example, a magnetic recording medium such as a hard disk, a non-volatile memory such as a flash memory, or the like is exemplified. In addition, the recording medium 256 may be attachable to/detachable from the state control device 200.

The input/output interface 258 connects, for example, the operation input device 260 or the display device 262. The operation input device 260 serves as the operation unit (not shown) and the display device 262 serves as the display unit (not shown). Here, as the input/output interface 258, for example, a USB port, a DVI terminal, an HDMI (a registered trademark) terminal, various processing circuits or the like may be exemplified.

In addition, the operation input device 260 is, for example, provided on the state control device 200 and connected with the input/output interface 258 in the inside of the state control device 200. As the operation input device 260, for example, buttons, arrow keys, a rotation-type selector such as a jog dial, a combination thereof, or the like is exemplified.

Furthermore, the display device 262 is, for example, provided on the state control device 200, and connected with the input/output interface 258 in the inside of the state control device 200. As the display device 262, for example, a liquid crystal display, an organic EL display or the like is exemplified.

Note that it is a matter of course that the input/output interface 258 can be connected to an external device such as an external operation input device (e.g., a keyboard, a mouse, etc.) and an external display device as external devices of the state control device 200. Furthermore, the display device 262 may be a device on which display and user operations are possible, for example, a touch screen, or the like.

The communication interface 264 is a communication means provided in the state control device 200, and functions as the communication unit 202 for performing wireless or wired communication with an external device such as the information processing device 100 via a network (or directly). Here, as the communication interface 264, for example, a communication device compatible with the first communication, or a communication device compatible with the second communication is exemplified.

With the configuration shown in FIG. 11, for example, the state control device 200 performs the process of the state control method according to the present embodiment. Note that a hardware configuration of the state control device 200 according to the present embodiment is not limited to the configuration shown in FIG. 11.

For example, the state control device 200 may not be provided with the communication interface 264 when the device performs communication with an external device such as the information processing device 100 via a connected external communication device.

In addition, the state control device 200, for example, may be further provided with another communication device whose communication scheme is different from that of the communication interface 264. In addition, the state control device 200 can also employ a configuration including the recording medium 256, the operation input device 260, or the display device 262.

The example of the configuration of the state control device 200 will be described with reference to FIG. 10 again. The communication unit 202 is a communication means provided in the state control device 200, and performs wireless or wired communication with an external device such as the information processing device 100 via a network (or directly). In addition, communication of the communication unit 202 is controlled by, for example, the control unit 204.

Here, as the communication unit 202, for example, a communication device compatible with the first communication, or a communication device compatible with the second communication is exemplified. The state control device 200 performs communication with the information processing device 100 via, for example, the communication unit 202 using the first communication or the second communication.

The control unit 204 is constituted by, for example, an MPU, and the like, and plays a role in controlling the state control device 200 overall. The control unit 204 is provided with, for example, the state control unit 210, and plays a leading role in performing the process of the state control method according to the present embodiment.

The state control unit 210 plays a leading role in performing the state control process of the state control method according to the present embodiment, and causes an external device such as the information processing device 100 to set an access state of an application.

Based on a user operation of a user of the state control device 200, for example, the state control unit 210 generates an access state setting request for setting an access state corresponding to the user operation. Then, the state control unit 210 causes the communication unit 202 or the like to transmit, for example, the generated access state setting request to the external device, and thereby causes the external device to set an access state.

With the state control unit 210 provided, for example, the control unit 204 actively performs the process of the state control method according to the present embodiment.

With the configuration shown in FIG. 10, for example, the state control device 200 performs the process of the state control method according to the present embodiment, and thus causes the external device such as the information processing device 100 to set an access state of an application.

As the state control device 200 causes the external device such as the information processing device 100 to set an access state of an application, possibility of execution of each application is controlled in the external device according to the set access state. Therefore, the state control device 200 can achieve enhancement of user convenience in executing the application with, for example, the configuration shown in FIG. 10.

In addition, with the configuration shown in FIG. 10, for example, the state control device 200 can exhibit the effects obtained by performing the process of the state control method according to the present embodiment, for example, as described above.

Note that a configuration of the state control device according to the present embodiment is not limited to the configuration shown in FIG. 10.

The state control device according to the present embodiment, for example, can be provided with the state control unit 210 separately from the control unit 204 (for example, realized in a different processing circuit). In addition, the state control device according to the present embodiment may be configured to perform processes of the state control unit 210 with a plurality of processing circuits.

Furthermore, for example, the state control device according to the present embodiment may not be provided with the communication unit 202 when the device performs communication with an external device via a connected external communication device.

Although the information processing device has been described above as the present embodiment, the present embodiment is not limited thereto. The present embodiment can be applied to various apparatuses, for example, IC cards that can communicate based on NFC, communication devices such as smartphones and mobile telephones, tablet-type devices, computers such as personal computers (PCs), video/music reproduction devices (or video/music recording/reproduction devices), game devices, and the like. In addition, the present embodiment can also be applied to, for example, processing ICs that can be incorporated into such apparatuses described above.

In addition, although the state control device has been described as the present embodiment, the present embodiment is not limited thereto. The present embodiment can be applied to various apparatuses, for example, communication devices such as smartphones and mobile telephones, tablet-type devices, computers such as PCs, video/music reproduction devices (or video/music recording/reproduction devices), game devices, and the like. In addition, the present embodiment can also be applied to, for example, processing ICs that can be incorporated into such apparatuses described above.

(Program According to Present Embodiment) [i] Program for Causing Computer to Function as Information Processing Device According to Present Embodiment

Enhancement of user convenience in executing an application can be achieved when a processor or the like of a computer executes a program for causing the computer to function as the information processing device according to the present embodiment (for example, a program that can execute the process of the information processing method according to the present embodiment such as “the process (state control process) described in (1) above” or “the process (state control process) described in (1) above and the process (execution process) described in (2) above”).

In addition, the program for enabling a computer to function as the information processing device according to the present embodiment may be executed by a processor of the computer to exhibit the effects obtained from the process of the aforementioned information processing method according to the present embodiment.

[ii] Program for Causing Computer to Function as State Control Device According to Present Embodiment

An external device such as the information processing device according to the present embodiment can be caused to set an access state of an application as a processor or the like of a computer executes a program for causing the computer to function as the state control device according to the present embodiment (for example, a program that can execute the process of the state control method according to the present embodiment such as state control process). Thus, when the processor or the like of the computer executes the program for causing the computer to function as the state control device according to the present embodiment, enhancement of user convenience in executing the application can be achieved.

In addition, when the processor or the like of the computer executes the program for causing the computer to function as the state control device according to the present embodiment, the effects obtained by performing the process of the state control method according to the present embodiment described above can be exhibited.

### (Use Case According to Present Embodiment)

Next, an example of a use case in which an application for which an access state is set through the process of the information processing method according to the present embodiment and the process of the state control method according to the present embodiment is used will be described.

### [A] First Use Case: Payment of Electronic Money

First, a use case in which payment of electronic money is performed will be described as a first use case. The first use case will be described below exemplifying a case in which the second communication is NFC and the first communication is communication of a communication scheme different from NFC, such as BLE.

FIG. 12 is an illustrative diagram for describing the first use case according to the present embodiment. FIG. 12 shows an information processing system including the information processing device 100, a payment processing device 300 for payment, and an upper-level communication device 400 corresponding to the information processing device 100. R shown in FIG. 12 represents a communication range of the first communication between the information processing device 100 and the upper-level communication device 400. In addition, the upper-level communication device 400 may have a function of performing the process of the state control method according to the present embodiment.

As the payment processing device 300, for example, any of various apparatuses including a reader/writer that can communicate based on NFC (or a 16 device having a reader/writer function), a device installed in a store or the like (for example, a device for a Point Of Sale (POS) or the like), a computer such as a PC or a server, or the like is exemplified.

In addition, as the upper-level communication device 400, for example, any of various apparatuses including a communication device such as a smartphone or a mobile telephone, a tablet type device, a computer such as a PC, a video/music reproduction device (or a video/music recording/reproduction device), a game device, or the like is exemplified.

The first use case is described below based on the following premises.
The information processing device 100 and the payment processing device 300 perform communication with each other using NFC.
The information processing device 100 and the upper-level communication device 400 are connected with each other in communication of a communication scheme different from NFC, such as BLE.
The information processing device 100 includes an application A for performing a payment process relating to electronic money A and an application B for performing a payment process relating to electronic money B.
An access state of the application A is the authentication available state (A of FIG. 1), and an access state of the application B is the all-communication available state.

Payment of electronic money in the first use case is realized according to, for example, the following flow.
A user of the information processing device 100 performs a touch operation with respect to the payment processing device 300 using the information processing device 100 to perform payment using the electronic money A.
When a payment request is acquired from the payment processing device 300 in NFC, the information processing device 100 determines whether payment using the electronic money A is possible based on the access state set for the application A or the like. Then, when it is determined that payment using the electronic money A is possible, the information processing device 100 executes the application A to perform a process using the electronic money A.
The payment processing device 300 performs a payment process relating to the electronic money A based on a response transmitted from the information processing device 100 that the device can perform a process according to the payment request. As a result, payment of electronic money using the electronic money A is realized in the information processing system.

An example of a process of the first use case will be described below.

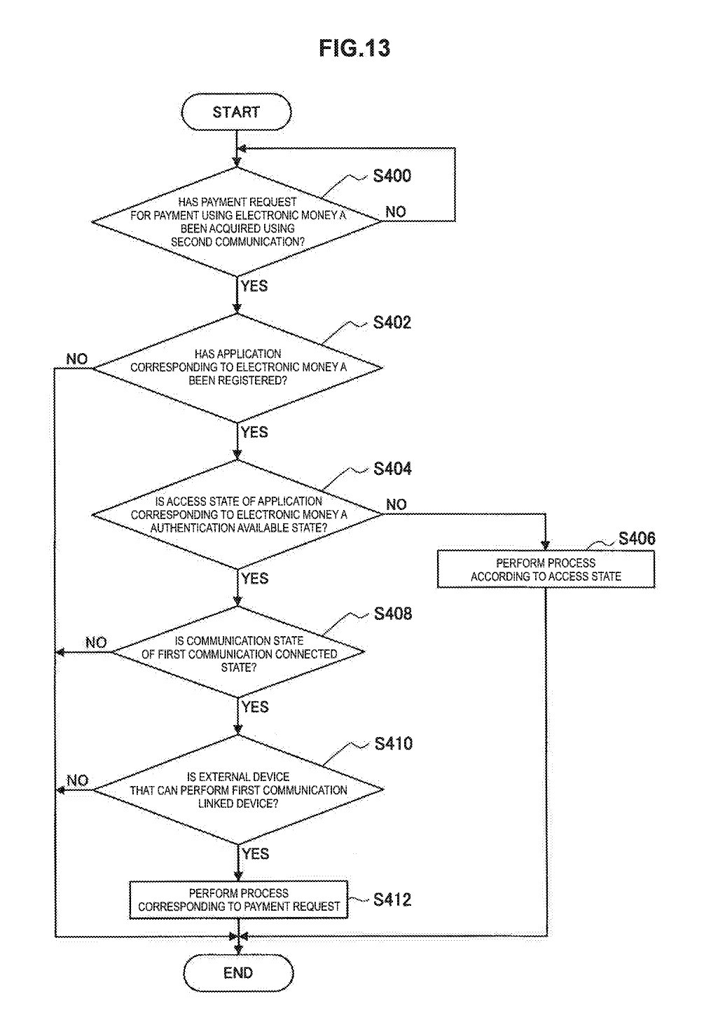

FIG. 13 is an illustrative diagram for describing the first use case according to the present embodiment, showing the example of the process of the information processing device 100 in the first use case.

In addition, FIG. 13 shows the example the process of the information processing device 100 in which a user of the information processing device 100 performs a touch operation with respect to the payment processing device 300 using the information processing device 100, and thus NFC (an example of the second communication) between the information processing device 100 and the payment processing device 300 is started.

Here, when a carrier for NFC is detected, for example, the information processing device 100 performs no process according to a signal transferred from an operation device such as a button provided on the information processing device 100.

By controlling execution of a process according to a signal transferred from an operation device when a carrier for NFC is detected as described above, the information processing device 100 can prevent an erroneous operation attributable to the carrier for NFC.

The information processing device 100 determines whether or not a payment request for payment using the electronic money A has been acquired using NFC (an example of the second communication) (S400).

When no payment request is determined to have been acquired in Step S400, the information processing device 100 does not advance the process shown in FIG. 13.

In addition, when a payment request is determined to have been acquired in Step S400, the information processing device 100 determines whether or not the application A corresponding to the electronic money A for the acquired payment request has been registered (S402). Here, as a state in which the application is registered, for example, a state in which the application is installed in the information processing device 100 is exemplified.

When the application A corresponding to the electronic money A is determined not to have been registered in Step S402, the information processing device 100 ends the process shown in FIG. 13 without performing a process corresponding to the payment request. In addition, when the process corresponding to the payment request is not performed, the information processing device 100, for example, gives a response that the process corresponding to the payment request was not performed normally to the payment processing device 300.

In addition, when the application A corresponding to the electronic money A is determined to have been registered in Step S402, the information processing device 100 determines whether or not the application A corresponding to the electronic money A is in the authentication available state (A of FIG. 1) (S404).

When the application A corresponding to the electronic money A is determined not to be in the authentication available state in Step S404, the information processing device 100 performs a process according to an access state set for the application A, other than the authentication available state (A of FIG. 1) (S406).

When, for example, the access state set for the application A is the all-communication available state (B of FIG. 1) or the second communication available state (D of FIG. 1), the information processing device 100 executes the application A, and performs a process corresponding to the payment request.

In addition, when the access state set for the application A is the first communication available state (D of FIG. 1) or the unavailable state (E of FIG. 1), for example, the information processing device 100 does not execute the application A, and thus does not perform a process corresponding to the payment request. When the process corresponding to the payment request is not performed, the information processing device 100, for example, gives a response that the process corresponding to the payment request was not performed normally to the payment processing device 300.

In addition, when the application A corresponding to the electronic money A is determined to be in the authentication available state in Step S404, the information processing device 100 determines whether or not a communication state of the first communication is a connected state (S408).

When a communication state of the first communication is determined not to be a connected state in Step S408, the information processing device 100 ends the process shown in FIG. 13 without performing the process corresponding to the payment request. In addition, when the process corresponding to the payment request is not performed, the information processing device 100, for example, gives a response that the process corresponding to the payment request was not performed normally to the payment processing device 300.

In addition, when a communication state of the first communication is determined to be a connected state in Step S408, the information processing device 100 determines whether or not an external device that can perform the first communication is a specific linked device (S410). The information processing device 100 determines whether or not the external device that can perform the first communication is a specific device based on, for example, identification information acquired from the external device using the first communication.

When the external device that can perform the first communication is determined not to be a specific device in Step S410, the information processing device 100 ends the process shown in FIG. 13 without performing the process corresponding to the payment request. In addition, when the process corresponding to the payment request is not performed, the information processing device 100, for example, gives a response that the process corresponding to the payment request was not performed normally to the payment processing device 300.

Furthermore, when the external device that can perform the first communication is determined to be a specific device in Step S410, the information processing device 100 performs the process corresponding to the payment request (S412).

In the first use case, the information processing device 100 performs the process shown in, for example, FIG. 13. Through the process shown in FIG. 13, for example, selective execution of the application A corresponding to the electronic money A is realized in the information processing device 100 based on an access state set for the application A corresponding to the electronic money A, or the like. Thus, in the information processing system according to the first use case, the information processing device 100 selectively performs payment using the electronic money A based on an access state set for the application A corresponding to the electronic money A, or the like.

### [B] Second Use Case: Facility Entry/Exit Management

Next, as a second use case, a use case in which facility entry/exit management is performed will be described. The second use case will be described exemplifying a case in which the first communication is communication of a communication scheme whose communicable range is wider than NFC, like wireless communication using IEEE 802.15.1 such as BLE, or wireless communication using IEEE 802.11.

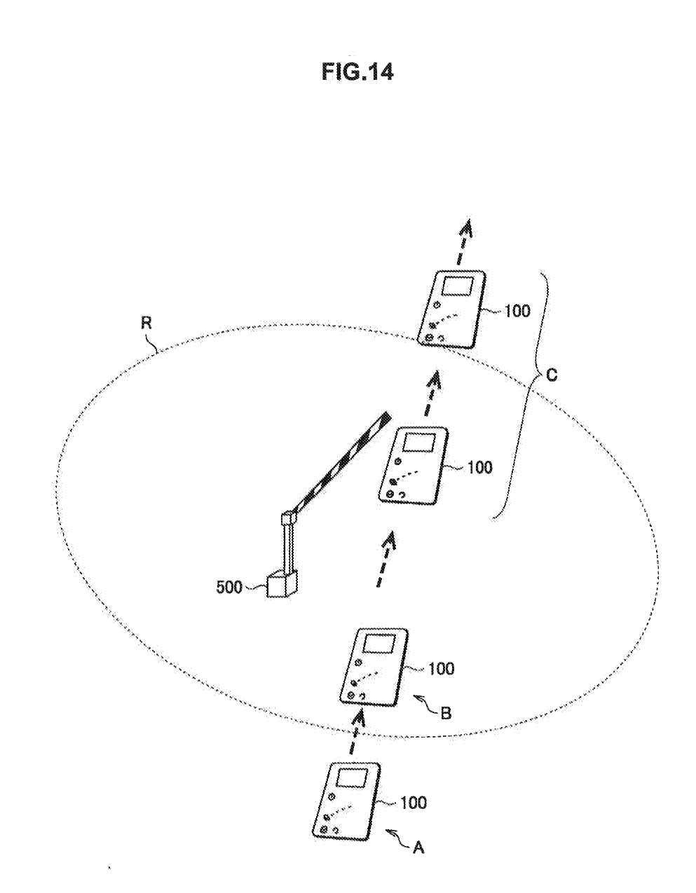

FIG. 14 is an illustrative diagram for describing a second use case according to the present embodiment. FIG. 14 shows an information processing system that includes the information processing device 100 and a management device 500 that manages entry/exit by controlling opening and closing of an entry/exit gate. R shown in FIG. 14 represents a communicable range of the first communication of the management device 500.

As the management device 500, for example, any of various apparatuses including a device installed at an entry/exit gate, or a computer such as a PC or a server is exemplified.

The second use case will be described below based on the following premises.
The first communication unit 102 provided in the information processing device 100 is in a state in which the first communication is possible (an activated state).
The information processing device 100 includes an application A for performing a payment process relating to electronic money A, an application B for performing a payment process relating to electronic money B, and an entry certificate application C relating to facility entry/exit.
An access state of the application A is the unavailable state (E of FIG. 1), an access state of the application B is the all-communication available state, and an access state of the admission card application C is the communication available state.

Facility entry/exit management in the second use case is realized according to, for example, the following flow.
A user approaches an entry/exit gate holding the information processing device 100 (A of FIG. 14).
When the information processing device 100 enters the communicable range R of the first communication of the management device 500, the first communication is performed between the information processing device 100 and the management device 500 (B of FIG. 14).
The management device 500 determines whether the entry/exit gate can be allowed to be opened based on information (data) included in the information processing device 100. When the entry/exit gate can be allowed to be opened, the user can go through the entry/exit gate without performing an operation such as a touch operation (C of FIG. 14).

An example of a process in the second use case will be introduced below.

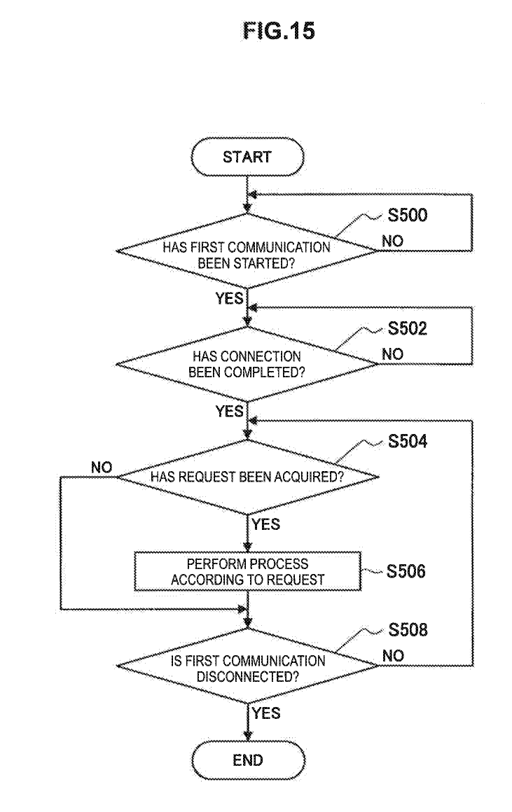

FIG. 15 is an illustrative diagram for describing the second use case according to the present embodiment, showing the example of the process of the information processing device 100 in the second use case.

The information processing device 100 determines whether or not the first communication with an external device such as the management device 500 has been started (S500). When the first communication is determined not to have been started in Step S500, the information processing device 100 does not advance the process until the first communication is determined to have been started.

In addition, when the first communication is determined to have been started in Step S500, the information processing device 100 determines whether or not connection based on the first communication has been completed and thus the first communication with the external device such as the management device 500 is possible (S502).

When connection based on the first communication is determined not to have been completed in Step S502, the information processing device 100 does not advance the process until connection based on the first communication is determined to have been completed.

In addition, when connection based on the first communication is determined to have been completed in Step S502, the information processing device 100 determines whether or not a request has been acquired via the first communication (S504).

When no request is determined to have been acquired in Step S504, the information processing device 100 performs a process of Step S508 to be described below.

In addition, when no request is determined to have been acquired in Step S504, the information processing device 100 performs a process according to the acquired request (S506). As an example of a process according to the request in the second use case, a process corresponding to a process of the management device 500 to be described below, such as transmission of a list of applications, is exemplified.

When no request is determined to have been acquired in Step S504S or the process of Step S506 is performed, the information processing device 100 determines whether or not the first communication with the external device such as the management device 500 is disconnected (S508).

When the first communication with the external device is determined not to be disconnected in Step S508, the information processing device 100 repeats the processes from Step S504. Furthermore, when the first communication with the external device is determined to be disconnected in Step S508, the information processing device 100 ends the process shown in FIG. 15.

The information processing device 100 performs, for example, the process shown in FIG. 15 in the second use case.

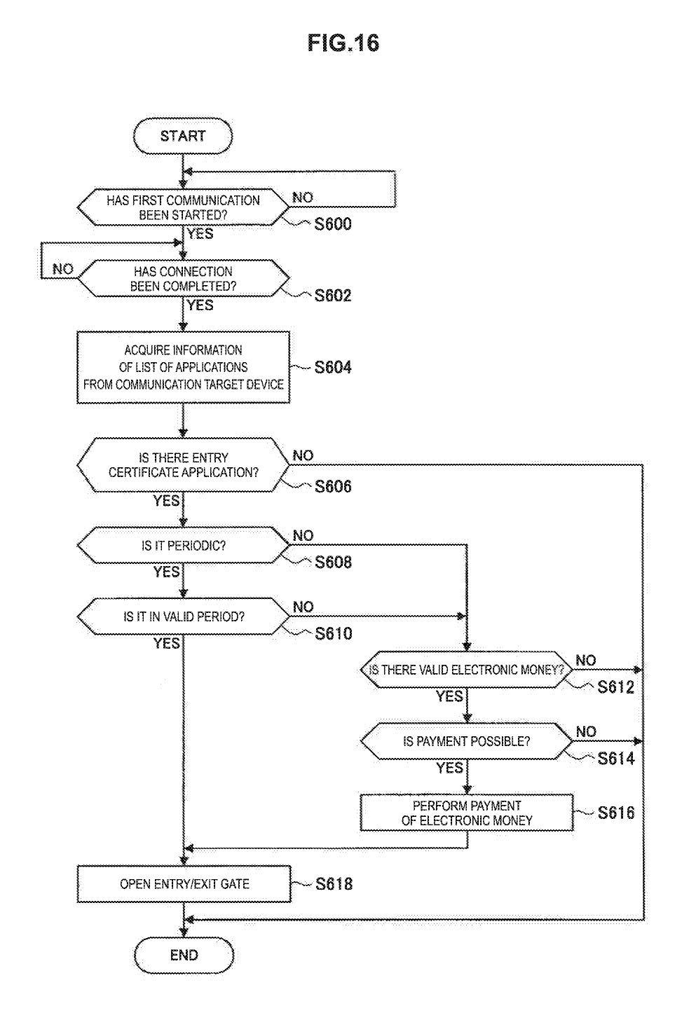

FIG. 16 is an illustrative diagram for describing the second use case according to the present embodiment, showing an example of a process of the management device 500 in the second use case.

The management device 500 determines whether or not the first communication with an external device such as the information processing device 100 has been started (S600). When the first communication is determined not to have been started in Step S600, the management device 500 does not advance the process until the first communication is determined to have been started.

In addition, when the first communication is determined to have been started in Step S500, the management device 500 determines whether or not connection based on the first communication has been completed, and thus the first communication with the external device such as the information processing device 100 is possible (S602).

When connection based on the first communication is determined not to have been completed in Step S602, the management device 500 does not advance the process until connection based on the first communication is determined to have been completed.

In addition, when connection based on the first communication is determined to have been completed in Step S602, the management device 500 acquires information of a list of applications from, for example, the communication target device of the first communication (S604). The management device 500 transmits, for example, a transmission request including a transmission command for causing the information of the list of applications to be transmitted to the communication target device of the first communication, and thereby acquires the information of the list of applications from the communication target device. Here, the information of the list of applications according to the present embodiment includes data regarding the applications, for example, data indicating each application registered in the communication target device, access states set for the respective applications, and the like.

Based on the acquired information of the list of applications, the management device 500 determines whether or not there is an entry certificate application (S606).

When it is determined that there is no entry certificate application in Step S606, the management device 500 ends the process shown in FIG. 16 without opening the entry/exit gate.

In addition, when it is determined that there is an entry certificate application in Step S606, the management device 500 determines whether or not the entry certificate application is an entry certificate application indicating a periodic entry certificate (S608). The management device 500 performs the determination of Step S608 with reference to, for example, a parameter included in the acquired information of the list of applications relating to the entry certificate application indicating whether or not it is periodic.

When the application is determined not to be an entry certificate application indicating a periodic entry certificate in Step S608, the management device 500 performs the process of Step S612 to be described below.

In addition, when the application is determined to be an entry certificate application indicating a periodic entry certificate in Step S608, the management device 500 determines whether or not the entry certificate application is in its valid period (S610). The management device 500 performs the determination of Step S610 with reference to, for example, a parameter included in the acquired information of the list of applications relating to the entry certificate application indicating the valid period.

When the application is determined to be in its valid period in Step S610, the management device 500 performs the process of Step S618 to be described below.

When the application is determined not to be an entry certificate application indicating a periodic entry certificate in Step S608, or determined not to be in its valid period in Step S610, the management device 500 determines whether or not there is valid electronic money (S612). The management device 500 performs the determination of Step S612 based on, for example, whether the acquired information of the list of applications includes an application corresponding to electronic money, or access information set for an application corresponding to electronic money.

When it is determined that there is no valid electronic money in Step S612, the management device 500 ends the process shown in FIG. 16 without opening the entry/exit gate.

In addition, when it is determined that there is valid electronic money in Step S612, the management device 500 determines whether or not payment is possible using the valid electronic money (S614). The management device 500 performs the determination of Step S614 with reference to, for example, a parameter included in the acquired information of the list of applications relating to the application corresponding to the electronic money indicating the value equivalent to a balance of the money.

When it is determined that payment is not possible in Step S614, the management device 500 ends the process shown in FIG. 16 without opening the entry/exit gate.

In addition, when it is determined that payment is possible in Step S614, the management device 500 performs payment of electronic money using the valid electronic money of the information processing device 100 (S616).

When the application is determined to be in its valid period in Step S610, or the process of Step S616 is completed normally, the management device 500 opens the entry/exit gate (S618).

The management device 500 performs the process shown in FIG. 16, for example, in the second use case.

In the information processing system according to the second use case, for example, the information processing device 100 performs the process shown in FIG. 15, the management device 500 performs the process shown in FIG. 16, and thus the entry/exit gate is selectively opened based on an access state set for an application in the information processing device 100, or the like. Thus, facility entry/exit management of the second use case is realized as shown in FIG. 14 in the information processing system according to the second use case by, for example, the information processing device 100 performing the process shown in FIG. 15, and the management device 500 performing the process shown in FIG. 16.

The preferred embodiment(s) of the present disclosure have been described above with reference to the accompanying drawings, whilst the present disclosure is not limited to the above examples. A person skilled in the art may find various alterations and modifications within the scope of the appended claims, and it should be understood that they will naturally come under the technical scope of the present disclosure.

Although the programs for enabling a computer to function as, for example, the information processing device according to the present embodiment or the state control device according to the present embodiment (computer programs) have been described to be provided above, the present embodiment can further provide recording media in which the programs are stored respectively, or a recording medium in which the programs are stored together as well.

The above configuration shows an example of the present embodiment and naturally comes under the technical scope of the present disclosure.

In addition, the effects described in the present specification are merely illustrative and demonstrative, and not limitative. In other words, the technology according to the present disclosure can exhibit other effects that are evident to those skilled in the art along with or instead of the effects based on the present specification.

Additionally, the present technology may also be configured as below.

(1)

An information processing device including:

a state control unit configured to set, for each application, access states of an application which indicate possibility of execution of an application based on first communication and possibility of execution of the application based on second communication whose communication scheme is different from a communication scheme of the first communication,

wherein the access states capable of being set by the state control unit include an authentication available state in which execution of an application based on the first communication and execution of the application based on the second communication are selectively permitted according to a communication state of the first communication.

(2)

The information processing device according to (1), wherein, when a communication state of the first communication is a connected state in which communication is possible, execution based on the first communication and execution based on the second communication are permitted for an application for which the authentication available state is set as the access state.

(3)

The information processing device according to (1) or (2), wherein, when a communication state of the first communication is an unconnected state in which communication is not possible, neither execution based on the first communication nor execution based on the second communication is permitted for an application for which the authentication available state is set as the access state.

(4)

The information processing device according to any one of (1) to (3), wherein the access states set by the state control unit include an all-communication available state in which execution of an application based on the first communication and execution of the application based on the second communication are permitted.

(5)

The information processing device according to any one of (1) to (4), wherein the access states set by the state control unit include a first communication available state in which execution of an application based on the first communication is permitted but execution of the application based on the second communication is not permitted.

(6)

The information processing device according to any one of (1) to (5), wherein the access states set by the state control unit include a second communication available state in which execution of an application based on the second communication is permitted but execution of the application based on the first communication is not permitted.

(7)

The information processing device according to any one of (1) to (6), wherein the access states set by the state control unit include an unavailable state in which neither execution of an application based on the first communication nor execution of the application based on the second communication is permitted.

(8)

The information processing device according to any one of (1) to (7), wherein, based on a user operation, the state control unit sets an access state corresponding to the user operation for each application.

(9)

The information processing device according to (8), wherein the state control unit does not set the authentication available state for a setting target application of the access states.

(10)

The information processing device according to (8) or (9), wherein, when an access state set for a setting target application of the access states is the authentication available state, the state control unit does not set the access state corresponding to the user operation for the setting target application.

(11)

The information processing device according to any one of (1) to (10), wherein, based on an access state setting request transmitted from an external device, the state control unit sets an access state corresponding to the access state setting request for each application.

(12)

The information processing device according to any one of (1) to (11), further including:

a processing unit configured to selectively execute an execution target application and perform a process corresponding to the executed application according to a set access state.

(13)

The information processing device according to any one of (1) to (12), further including:

a first communication unit configured to be capable of communicating with an external device using the first communication.

(14)

The information processing device according to any one of (1) to (13), further including:

a second communication unit configured to be capable of communicating with an external device using the second communication.

(15)

A state control device including:

a state control unit configured to cause an external device to set access states of an application which indicate possibility of execution of the application based on first communication and possibility of execution of the application based on second communication whose communication scheme is different from a communication scheme of the first communication,

wherein the access states capable of being set by the state control unit include an authentication available state in which execution of an application based on the first communication and execution of the application based on the second communication are selectively permitted according to a communication state of the first communication.

(16)

An information processing method that is executed by an information processing device, the method including:

a step of setting, for each application, access states of an application which indicate possibility of execution of an application based on first communication and possibility of execution of the application based on second communication whose communication scheme is different from a communication scheme of the first communication,

wherein the access states capable of being set in the setting step include an authentication available state in which execution of an application based on the first communication and execution of the application based on the second communication are selectively permitted according to a communication state of the first communication.

(17)

A state control method that is executed by a state control device, the method including:

a step of causing an external device to set access states of an application which indicate possibility of execution of the application based on first communication and possibility of execution of the application based on second communication whose communication scheme is different from a communication scheme of the first communication,

wherein the access states capable of being set in the setting step include an authentication available state in which execution of an application based on the first communication and execution of the application based on the second communication are selectively permitted according to a communication state of the first communication.

(18)

A program that causes a computer to execute a step of setting, for each application, access states of an application which indicate possibility of execution of an application based on first communication and possibility of execution of the application based on second communication whose communication scheme is different from a communication scheme of the first communication,

wherein the access states capable of being set in the setting step include an authentication available state in which execution of an application based on the first communication and execution of the application based on the second communication are selectively permitted according to a communication state of the first communication.

(19)

A program that causes a computer to execute a step of causing an external device to set access states of an application which indicate possibility of execution of the application based on first communication and possibility of execution of the application based on second communication whose communication scheme is different from a communication scheme of the first communication,

wherein the access states capable of being set in the setting step include an authentication available state in which execution of an application based on the first communication and execution of the application based on the second communication are selectively permitted according to a communication state of the first communication.

### REFERENCE SIGNS LIST

100 information processing device
102 first communication unit
104 second communication unit
106, 204 control unit
110, 210 state control unit
112 processing unit
200 state control device
202 communication unit
300 payment processing device
400 upper-level communication device
500 management device

1. An information processing device comprising:
a state control unit configured to set, for each application, access states of an application which indicate possibility of execution of an application based on first communication and possibility of execution of the application based on second communication whose communication scheme is different from a communication scheme of the first communication,
wherein the access states capable of being set by the state control unit include an authentication available state in which execution of an application based on the first communication and execution of the application based on the second communication are selectively permitted according to a communication state of the first communication.

2. The information processing device according to claim 1, wherein, when a communication state of the first communication is a connected state in which communication is possible, execution based on the first communication and execution based on the second communication are permitted for an application for which the authentication available state is set as the access state.

3. The information processing device according to claim 1, wherein, when a communication state of the first communication is an unconnected state in which communication is not possible, neither execution based on the first communication nor execution based on the second communication is permitted for an application for which the authentication available state is set as the access state.

4. The information processing device according to claim 1, wherein the access states set by the state control unit include an all-communication available state in which execution of an application based on the first communication and execution of the application based on the second communication are permitted.

5. The information processing device according to claim 1, wherein the access states set by the state control unit include a first communication available state in which execution of an application based on the first communication is permitted but execution of the application based on the second communication is not permitted.

6. The information processing device according to claim 1, wherein the access states set by the state control unit include a second communication available state in which execution of an application based on the second communication is permitted but execution of the application based on the first communication is not permitted.

7. The information processing device according to claim 1, wherein the access states set by the state control unit include an unavailable state in which neither execution of an application based on the first communication nor execution of the application based on the second communication is permitted.

8. The information processing device according to claim 1, wherein, based on a user operation, the state control unit sets an access state corresponding to the user operation for each application.

9. The information processing device according to claim 8, wherein the state control unit does not set the authentication available state for a setting target application of the access states.

10. The information processing device according to claim 8, wherein, when an access state set for a setting target application of the access states is the authentication available state, the state control unit does not set the access state corresponding to the user operation for the setting target application.

11. The information processing device according to claim 1, wherein, based on an access state setting request transmitted from an external device, the state control unit sets an access state corresponding to the access state setting request for each application.

12. The information processing device according to claim 1, further comprising:
a processing unit configured to selectively execute an execution target application and perform a process corresponding to the executed application according to a set access state.

13. The information processing device according to claim 1, further comprising:
a first communication unit configured to be capable of communicating with an external device using the first communication.

14. The information processing device according to claim 1, further comprising:
a second communication unit configured to be capable of communicating with an external device using the second communication.

15. A state control device comprising:
a state control unit configured to cause an external device to set access states of an application which indicate possibility of execution of the application based on first communication and possibility of execution of the application based on second communication whose communication scheme is different from a communication scheme of the first communication,
wherein the access states capable of being set by the state control unit include an authentication available state in which execution of an application based on the first communication and execution of the application based on the second communication are selectively permitted according to a communication state of the first communication.

16. An information processing method that is executed by an information processing device, the method comprising:
a step of setting, for each application, access states of an application which indicate possibility of execution of an application based on first communication and possibility of execution of the application based on second communication whose communication scheme is different from a communication scheme of the first communication,
wherein the access states capable of being set in the setting step include an authentication available state in which execution of an application based on the first communication and execution of the application based on the second communication are selectively permitted according to a communication state of the first communication.

17. A state control method that is executed by a state control device, the method comprising:
a step of causing an external device to set access states of an application which indicate possibility of execution of the application based on first communication and possibility of execution of the application based on second communication whose communication scheme is different from a communication scheme of the first communication,
wherein the access states capable of being set in the setting step include an authentication available state in which execution of an application based on the first communication and execution of the application based on the second communication are selectively permitted according to a communication state of the first communication.

18. A program that causes a computer to execute a step of setting, for each application, access states of an application which indicate possibility of execution of an application based on first communication and possibility of execution of the application based on second communication whose communication scheme is different from a communication scheme of the first communication,
wherein the access states capable of being set in the setting step include an authentication available state in which execution of an application based on the first communication and execution of the application based on the second communication are selectively permitted according to a communication state of the first communication.

19. A program that causes a computer to execute a step of causing an external device to set access states of an application which indicate possibility of execution of the application based on first communication and possibility of execution of the application based on second communication whose communication scheme is different from a communication scheme of the first communication,
wherein the access states capable of being set in the setting step include an authentication available state in which execution of an application based on the first communication and execution of the application based on the second communication are selectively permitted according to a communication state of the first communication.
